(19) United States
(12) Patent Application Publication
(10) Pub. No.: US 2025/0181021 A1
(43) Pub. Date: Jun. 5, 2025

(54) IMAGE FORMING APPARATUS

(71) Applicant: BROTHER KOGYO KABUSHIKI KAISHA, Nagoya (JP)

(72) Inventors: Ayaka Ohira, Nagoya (JP); Saya Minoshima, Gifu (JP); Tadao Kyotani, Nagoya (JP)

(73) Assignee: BROTHER KOGYO KABUSHIKI KAISHA, Nagoya (JP)

(21) Appl. No.: 18/950,587

(22) Filed: Nov. 18, 2024

(30) Foreign Application Priority Data
Dec. 4, 2023 (JP) 2023-204793

(51) Int. Cl. G03G 15/00; G03G 15/20; G03G 21/16

(52) U.S. Cl. CPC G03G 15/657; G03G 15/2064; G03G 15/70; G03G 21/1638; G03G 21/1685; G03G 2215/00548; G03G 2221/1639

(57) ABSTRACT

An image forming apparatus includes a toner image carrier, a transfer roller, a fixing device, a movable chute, a movement device, and a controller. The transfer roller forms a transfer nip with the toner image carrier. The fixing device includes a rotatable heating body and a rotatable pressure body configured to form a fixing nip with the rotatable heating body. The movable chute guides the sheet and is movable between a first position and a second position located further away, than the first position, from a straight line connecting a downstream edge of the transfer nip and an upstream edge of the fixing nip. The controller controls the movement device to move the movable chute only between the first position and the second position. The movable chute is movable to a third position located further away, than the second position, from the straight line.

### REFERENCE TO RELATED APPLICATIONS

This application claims priority from Japanese Patent Application No. 2023-204793 filed on Dec. 4, 2023. The entire contents of the priority application are incorporated herein by reference.

### BACKGROUND ART

An image forming apparatus known in the art includes a fixing device, a guide, a solenoid, and a controller. The guide is rotatable between a first position and a second position below the first position and guides a sheet toward the fixing device.

While executing printing control, the controller turns the solenoid on before the sheet enters the fixing device to locate the guide in the first position. In response to a central portion of the sheet passing the distal end of the guide, the controller turns the solenoid off to locate the guide in the second position.

A rotational range of the guide is set by two fixed plates. The guide is located in the first position when the guide is in contact with an upper fixed plate. The guide is located in the second position when the guide is in contact with a lower fixed plate.

### SUMMARY

In such an image forming apparatus known in the art, the guide is only allowed to rotate within a range from the first position to the second position. Thus, a space into which a user inserts his/her hand when a sheet is jammed in the vicinity of the guide is small, which may make an operation of removing the jammed sheet (also referred below as “jam removal process”) complicated.

It is desirable to provide an image forming apparatus capable of enlarging the space into which a user inserts his/her hand during a jam removal process.

In one aspect, an image forming apparatus disclosed herein comprises a toner image carrier, a transfer roller, a fixing device, a movable chute, a movement device, and a controller.

The toner image carrier is configured to carry a toner image.

The transfer roller is configured to form a transfer nip with the toner image carrier and to transfer the toner image on the toner image carrier onto a sheet.

The fixing device is configured to fix the transferred toner image on the sheet. The fixing device comprises a rotatable heating body and a rotatable pressure body.

The rotatable heating body is configured to heat the sheet.

The rotatable pressure body is configured to form a fixing nip with the rotatable heating body and to apply pressure to the sheet.

The movable chute is configured to guide the sheet. The movable chute is located downstream of the transfer roller and upstream of the fixing device in a direction of conveyance of the sheet. The movable chute is movable between a first position and a second position. The second position is located further away, than the first position, from a straight line connecting a downstream edge of the transfer nip and an upstream edge of the fixing nip as viewed in an axial direction of the transfer roller.

The movement device is configured to move the movable chute.

The controller is configured to control the movement device to move the movable chute only between the first position and the second position.

The movable chute is movable to a third position located further away, than the second position, from the straight line.

Since the movable chute is movable to a third position located further away, than the second position, from the straight line, the movable chute is movable within a range larger than a range in which the movable chute is moved by the controller. Thus, a space into which a user inserts his/her hand during a jam removal process can be enlarged.

The movable chute may be movable in a direction from the first position toward the third position in a state where the movement device is not actuated.

Since the movable chute is movable in a direction from the first position toward the third position in a state where the movement device is not actuated, the movement device does not cause any resistance when the movable chute is moved to the third position. Thus, the movable chute can be moved smoothly.

The image forming apparatus may further comprise a spring that biases the movable chute toward the first position.

Since the image forming apparatus is configured such that the spring biases the movable chute toward the first position, the moving speed of the movable chute can be restrained, by the spring, from becoming too fast when the user pushes the movable chute from the first position toward the third position with a strong force.

The controller may be configured to control the movement device, if it is determined that a sheet is jammed during conveyance of the sheet, to position the movable chute at the first position.

Since the image forming apparatus is configured such that the movable chute is located in the first position when a sheet is jammed during conveyance of the sheet, the sheet in contact with the movable chute will be located in the vicinity of the straight line if the sheet is located between the transfer nip and the fixing nip. Thus, the user can easily grasp the sheet.

The movement device may comprise a solenoid actuator. In this case, the controller controls the solenoid actuator to move the movable chute between the first position and the second position.

The movable chute may have a guide surface that guides a sheet. In this case, the movement device may have a pushing surface that pushes the movable chute from a guide-surface side of the movable chute.

Since the image forming apparatus is configured such that the movement device pushes the movable chute from a guide-surface side of the movable chute, it is not necessary to locate the movement device within a space on the third-position side of the movable chute located in the first position. Thus, the movable chute can be moved smoothly.

The image forming apparatus may further comprise a linkage configured to be moved by a driving force of the solenoid actuator. In this case, the linkage comprises a first link, a second link, and a third link.

The first link has one end connected to the solenoid actuator and is movable in the axial direction.

The second link is connected to another end of the first link and is rotatable about a first axis in response to movement of the first link.

The third link is connected to the second link and has the pushing surface. The third link is configured to push the movable chute toward the second position in response to rotation of the second link.

Since the image forming apparatus is configured such that the linkage pushes the movable chute, the amount of travel of the movable chute from the first position to the second position can be increased.

The movable chute may be rotatable about a second axis, and may extend downstream from the second axis in the direction of conveyance. The second position may be lower than the first position. In this case, a distal end of the movable chute may be located above the transfer nip when the movable chute is located in the first position, and the distal end of the movable chute may be located below the transfer nip when the movable chute is located in the second position.

Since the image forming apparatus is configured such that the distal end of the movable chute located in the first position is located above the transfer nip, the sheet is supported by the distal end of the movable chute located in the first position when the sheet is jammed at a location between the transfer nip and the fixing nip. Thus, the user can easily grasp the trailing edge of the sheet. Further, when the sheet is supported by the distal end of the movable chute located in the first position, a space is likely to be formed between the movable chute and the sheet. Therefore, the user can insert his/her fingers into the space and easily grasp the sheet.

A downstream end of the movable chute in the direction of conveyance may be located further away from the straight line when the movable chute is located in the second position than when the movable chute is located in the first position, and may be located further away from the straight line when the movable chute is located in the third position than when the movable chute is located in the second position.

In another aspect, the image forming apparatus disclosed herein may have the following configuration.

The image forming apparatus comprises a transfer roller, a fixing device, a movable chute, a movement device, and a controller.

The transfer roller is configured to transfer a toner image onto a sheet.

The fixing device is configured to fix the transferred toner image on the sheet.

The movable chute is configured to guide the sheet. The movable chute is located downstream of the transfer roller and upstream of the fixing device in a direction of conveyance of the sheet. The movable chute is movable to a first position, to a second position, and to a third position in this order in a direction nonparallel to a surface of the sheet.

The movement device is configured to move the movable chute.

The controller is configured to control the movement device to move the movable chute only between the first position and the second position.

Since the movable chute is movable from the second position to the third position, the movable chute is movable within a range larger than a range in which the movable chute is moved by the controller. Thus, a space into which a user inserts his/her hand during a jam removal process can be enlarged.

The fixing device may comprise a fixing housing and a fixing shutter. In this case, the fixing housing has an opening through which a sheet conveyed toward the fixing device passes. The fixing shutter is movable between an open position in which the opening is uncovered and a closed position in which the opening is covered.

Since the image forming apparatus is formed such that the fixing device comprises the fixing shutter, it is possible to restrain, by the fixing shutter, a user's hand from entering the fixing housing in the jam removal process in which the sheet is jammed at a location between the transfer nip and the fixing nip.

The image forming apparatus may further comprise a main housing and a cartridge installable into and removable from the main housing. In this case, the fixing shutter may move from the closed position to the open position in the process of the cartridge being installed into the main housing. Further, the fixing shutter may move from the open position to the closed position in the process of the cartridge being removed from the main housing.

Since the image forming apparatus is configured such that the fixing shutter is opened and closed in conjunction with installation and removal of the cartridge, the fixing shutter closes when the user removes the cartridge from the main housing in the jam removal process in which the sheet is jammed at a location between the transfer nip and the fixing nip. Thus, the user's hand can be more reliably restrained from entering the fixing housing.

### BRIEF DESCRIPTION OF DRAWINGS

The above aspects, other advantages and further features will become more apparent by describing in detail illustrative, non-limiting embodiments thereof with reference to the accompanying drawings, in which:

FIG. 1 is an illustration of an image forming apparatus according to an embodiment.

FIG. 2 is an illustration showing a movable chute located in a first position and its surroundings as viewed in a first direction.

FIG. 3 is an illustration showing the movable chute located in a second position and its surroundings as viewed in the first direction.

FIG. 4 is an illustration showing the movable chute located in a third position and its surroundings as viewed in the first direction.

FIG. 5 is a perspective view of the movable chute.

FIG. 6 is a perspective view of a linkage and a solenoid actuator.

FIG. 7 is an illustration showing the linkage as observed when the movable chute is located in the first position.

FIG. 8 is an illustration showing the linkage as observed when the movable chute is located in the second position.

FIG. 9 is a perspective view of a third link.

FIG. 10 is a perspective view of a fixing device as observed when the fixing shutter is located in the closed position, as viewed from the other side in the second direction.

FIG. 11 is a perspective view of the fixing device as observed when the fixing shutter is located in the open position, as viewed from the other side in the second direction.

FIG. 12 is an exploded perspective view of a shutter actuation mechanism.

FIG. 13A is a side view of the fixing device as observed when the fixing shutter is located in the closed position.

FIG. 13B is an enlarged cross-sectional view of a spring contact portion and its surroundings.

FIG. 14A is a side view of the fixing device as observed when the fixing shutter is located in the open position.

FIG. 14B is an enlarged cross-sectional view of the spring contact portion and its surroundings.

FIG. 15 is an illustration of an image forming apparatus showing a main housing in which the fixing device is to be installed and other components.

FIG. 16 is an illustration showing a cartridge installable into and removable from the main housing.

FIG. 17 is an illustration showing a connection link as observed when the cartridge is removed from the main housing.

FIG. 18 is an illustration showing the connection link as observed when the cartridge is installed halfway into the main housing.

FIG. 19 is an illustration showing the connection link as observed when the cartridge is installed in the main housing.

FIG. 20 is an illustration of the movable chute and its surroundings as observed when the cartridge is removed from the main housing.

FIG. 21 is an exploded perspective view of the movable chute.

FIG. 22 is a perspective view of a metal plate as viewed from below.

FIG. 23A is an illustration of a chute body with the metal plate attached thereto as viewed from above.

FIG. 23B is an illustration of a chute body with the metal plate detached therefrom as viewed from above.

FIG. 24 is a cross-sectional view taken along line I-I of FIG. 23A.

FIG. 25 is a perspective view of the chute body and an attachment member in a disassembled state as viewed from below.

FIG. 26 is a cross-sectional view taken along line II-II of FIG. 23A.

FIG. 27A is an enlarged view of a downstream portion of the movable chute as viewed from below.

FIG. 27B is a cross-sectional view taken along line III-III of FIG. 27A.

### DESCRIPTION

An embodiment of the present disclosure will be described in detail referring to the drawings where appropriate.

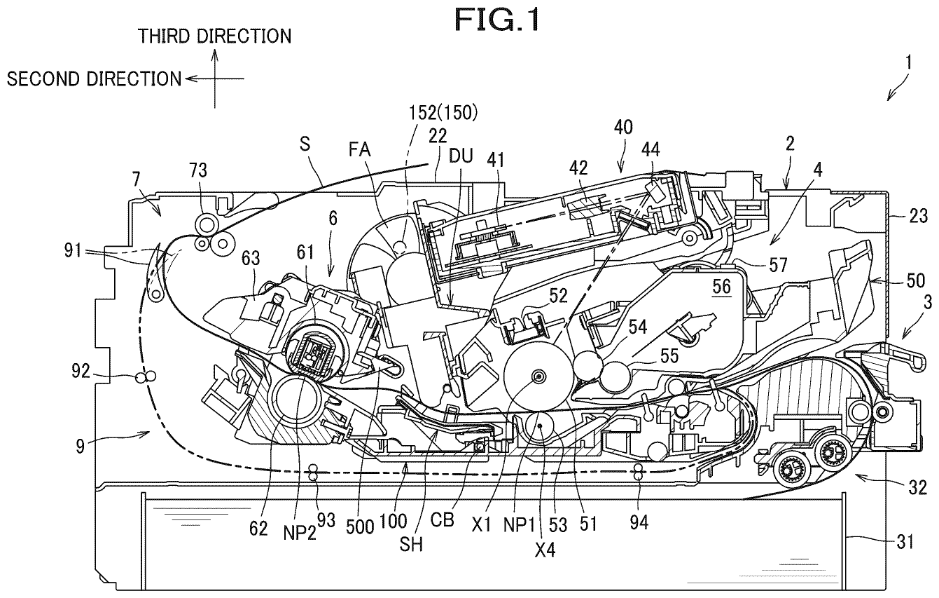

Referring now to FIG. 1, an image forming apparatus 1 is shown, which is a laser printer that forms an image on a sheet S. The image forming apparatus 1 comprises a main housing 2, a feeder unit 3, a process unit 4, a fixing device 6, and an ejection unit 7.

In the following description, the axial direction of a transfer roller 53, which will be described below, will also be referred to as “first direction”. The direction in which the sheet S is conveyed from the process unit 4 to the fixing device 6 is also referred to as “second direction”. The up-down direction is also referred to as “third direction”.

The first direction is nonparallel to the second direction. The third direction is nonparallel to the first direction and to the second direction. In this embodiment, the first direction is perpendicular to the second direction. The third direction is perpendicular to the first direction and to the second direction. The arrows showing the directions in the drawings point to “one side” in each direction. The side opposite to the one side in each direction will be referred to as “the other side” in each direction.

The feeder unit 3 comprises a sheet tray 31 and a sheet feeder device 32. The sheet tray 31 contains sheets S. The sheet feeder device 32 conveys the sheets S in the sheet tray 31 toward the process unit 4.

The process unit 4 forms a toner image on the fed sheet S. The process unit 4 comprises an exposure device 40 and a process cartridge 50 as an example of a cartridge.

The exposure device 40 is provided in an upper space within the main housing 2, and comprises a laser emitter (not shown), a rotatably driven polygon mirror 41, a lens 42, and a reflector 44. Laser light (indicated by dashed dotted lines) emitted from the laser emitter based on image data is reflected by or passes through the polygon mirror 41, the lens 42, the reflector 44 in this order and rapidly scans a surface of a photosensitive drum 51.

The process cartridge 50 is provided below the exposure device 40. The process cartridge 50 is configured to be installable into and removable from the main housing 2 through an opening formed when a front cover 23 of the main housing 2 is opened. The process cartridge 50 comprises a photosensitive drum 51 as an example of a toner image carrier, a charger 52, a transfer roller 53, a development roller 54, a supply roller 55, a toner container 56, and a toner memory 57.

The photosensitive drum 51 rotates about a rotation axis X1 extending in the first direction. The photosensitive drum 51 carries a toner image.

The transfer roller 53 rotates about a rotation axis X4 extending in the first direction. The transfer roller 53 transfers the toner image carried on the photosensitive drum 51 onto the sheet S. The transfer roller 53 forms a transfer nip NP1 in combination with the photosensitive drum 51. The transfer nip NP1 is formed between the transfer roller 53 and the photosensitive drum 51. Herein, the transfer nip NP1 is a portion of the transfer roller 53 that contacts the photosensitive drum 51. The toner memory 57 is a memory in which information about the process cartridge 50 is stored.

The fixing device 6 fixes the transferred toner image on the sheet S. The fixing device 6 is located downstream of the process unit 4 in the direction of conveyance of the sheet S. In the following description, “direction of conveyance of the sheet S” is also simply referred to as “conveyance direction”. The fixing device 6 comprises a rotatable heating body 61, a rotatable pressure body 62, and a fixing housing 63.

The rotatable heating body 61 is a member that heats the sheet S. The rotatable heating body 61 is an endless belt. The rotatable heating body 61 includes a heater inside and rotates while nipping the sheet S in combination with the rotatable pressure body 62 to heat the sheet S.

The rotatable pressure body 62 is a member that applies pressure to the sheet S. The rotatable pressure body 62 forms a fixing nip NP2 in combination with the rotatable heating body 61. The fixing nip NP2 is formed between the rotatable pressure body 62 and the rotatable heating body 61. Herein, the fixing nip NP2 is a portion of the rotatable heating body 61 that contacts the rotatable pressure body 62. The rotatable pressure body 62 is a roller with a surface formed of a non-conductive elastic body. The rotatable heating body 61 and the rotatable pressure body 62 are pressed against each other by a pressing member (not shown).

The fixing housing 63 is a frame that covers the rotatable heating body 61 and the rotatable pressure body 62. The fixing housing 63 supports the rotatable heating body 61 and the rotatable pressure body 62 in a manner that allows the rotatable heating body 61 and the rotatable pressure body 62 to rotate.

In the process unit 4, the surface of the photosensitive drum 51 is charged by the charger 52 and thereafter exposed to laser light emitted from the exposure device 40 to form an electrostatic latent image on the photosensitive drum 51. Toner in the toner container 56 is supplied to the development roller 54 via the supply roller 55 and is carried on the development roller 54.

The toner carried on the development roller 54 is supplied to the electrostatic latent image formed on the photosensitive drum 51. As a result, the electrostatic latent image is visualized and a toner image is formed on the photosensitive drum 51. Subsequently, the sheet S fed from the feeder unit 3 is conveyed through between the photosensitive drum 51 and the transfer roller 53 (transfer nip NP1) and a transfer bias is applied to the transfer roller 53 to thereby transfer the toner image carried on the photosensitive drum 51 onto the sheet S. The sheet S is then conveyed through between the rotatable heating body 61 and the rotatable pressure body 62 (fixing nip NP2) to thereby thermally fix the transferred toner image on the sheet S.

The ejection unit 7 conveys the sheet S on which the toner image is thermally fixed to the outside of the main housing 2. The ejection unit 7 comprises an ejection roller 73. The ejection roller 73 ejects the sheet S onto the output tray 22.

The image forming apparatus 1 further comprises a reconveyance mechanism 9. The reconveyance mechanism 9 conveys the sheet S to the process unit 4 again with the front side and the back side of the sheet S reversed to form an image on a second surface on the back side of the sheet S after an image is formed on a first surface of the sheet S. In FIG. 1, the sheet S being reconveyed is shown by a dashed-double dotted line.

The reconveyance mechanism 9 comprises a flapper 91 and a plurality of reconveyance rollers 92, 93, 94. The flapper 91 is rotatable between an initial position shown by a solid line and a reconveyance position shown by a dashed-double dotted line. When the flapper 91 is located in the initial position, the sheet S ejected from the fixing device 6 is guided toward the output tray 22. When the flapper 91 is located in the reconveyance position, the sheet S ejected from the fixing device 6 is guided to a reconveyance path by the ejection roller 73 rotating in the opposite direction at a predetermined timing.

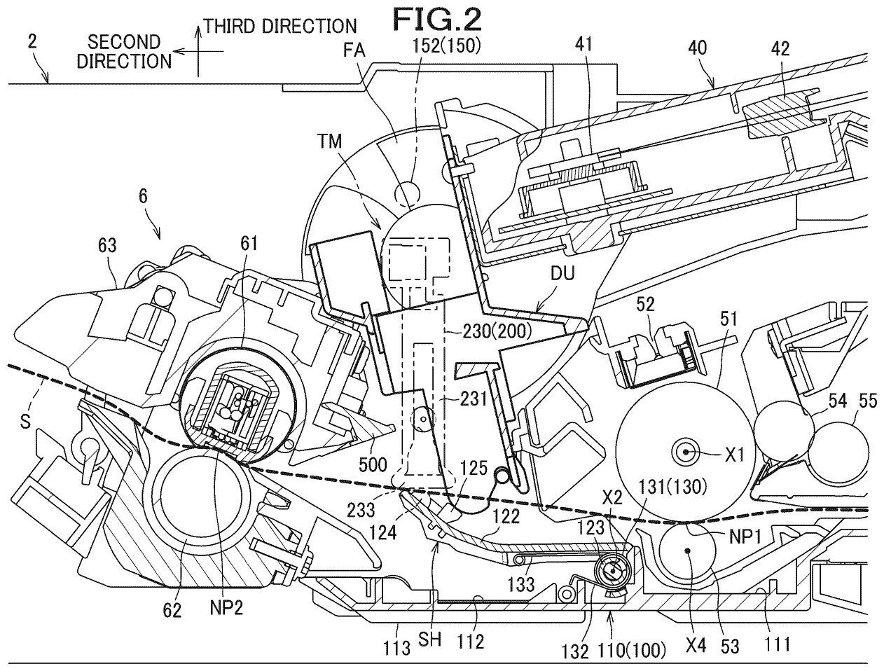

The image forming apparatus 1 further comprises a guide member 100. The guide member 100 is located below the process cartridge 50 and guides the sheet S from the transfer nip NP1 toward the fixing nip NP2. The guide member 100 also guides the sheet S in the reconveyance path toward the transfer nip NP1. The reconveyance path is formed on an underside of the guide member 100. As shown in FIG. 2, the guide member 100 includes a base portion 110, a movable chute SH, and a spring 130.

The base portion 110 has a first recess 111, a second recess 112, and a bottom surface 113. The first recess 111 is located on an upper surface of the base portion 110 at an end of the base portion 110 on the other side in the second direction. The first recess 111 is a portion of the base portion 110 in which a part of the transfer roller 53 is located. The second recess 112 is located on the upper surface of the base portion 110 at an end of the base portion 110 on the one side in the second direction. The second recess 112 is a portion of the base portion 110 that supports the movable chute SH in a manner that allows the movable chute SH to rotate. The bottom surface 113 is an underside of the base portion 110 that guides the sheet S being conveyed in the reconveyance path.

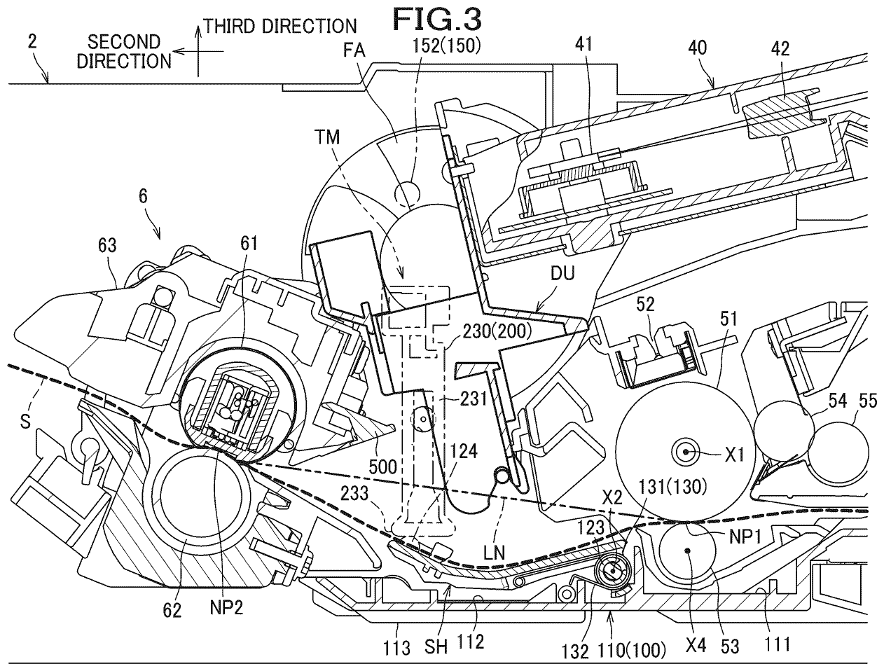

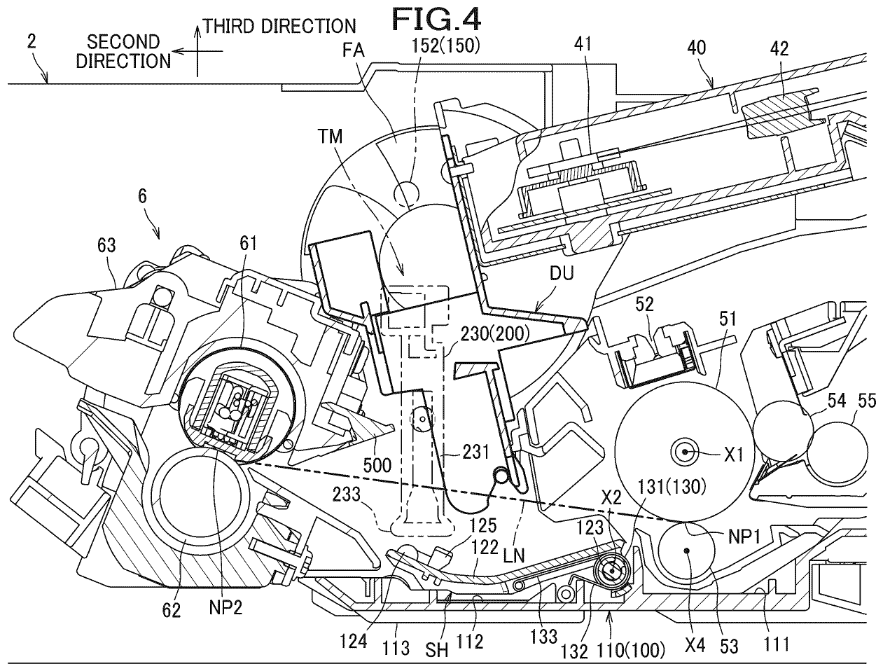

The movable chute SH is located between the photosensitive drum 51 and the fixing device 6 in the conveyance direction of the sheet S. In other words, the movable chute SH is located downstream of the transfer roller 53 and upstream of the fixing device 6 in the conveyance direction of the sheet S. The movable chute SH guides the sheet S. The movable chute SH is movable to a first position shown in FIG. 2, to a second position shown in FIG. 3, and to a third position shown in FIG. 4. The movable chute SH is rotatable within a range from the first position to third position.

The movable chute SH is movable to the first position, to the second position, and to the third position in this order in a direction nonparallel to a surface of the sheet S. The second position is located further away, than the first position, from a straight line LN (see FIG. 3) connecting a downstream edge of the transfer nip NP1 and an upstream edge of the fixing nip NP2 as viewed in the axial direction of the transfer roller 53. The straight line LN connecting the downstream edge of the transfer nip NP1 and the upstream edge of the fixing nip NP2 is omitted in FIG. 2 because it overlaps the sheet S shown by a dashed line. The third position is located further away, than the second position, from the straight line LN.

In the present embodiment, the second position is lower than the first position. The third position is lower than the second position. The movable chute SH is rotatable between the first position and the third position about a rotation axis X2 as an example of a second axis.

The movable chute SH extends downstream from the rotation axis X2 in the conveyance direction. When the movable chute SH is located in the first position, the distal end of the movable chute SH, i.e., the downstream end of the movable chute SH in the conveyance direction, is located above the transfer nip NP1. When the movable chute SH is located in the second position or the third position, the distal end of the movable chute SH is located below the transfer nip NP1.

The downstream end of the movable chute SH in the conveyance direction is located further away from the straight line LN when the movable chute SH is located in the second position than when the movable chute SH is located in the first position. The downstream end of the movable chute SH in the conveyance direction is located further away from the straight line LN when the movable chute SH is located in the third position than when the movable chute SH is located in the second position.

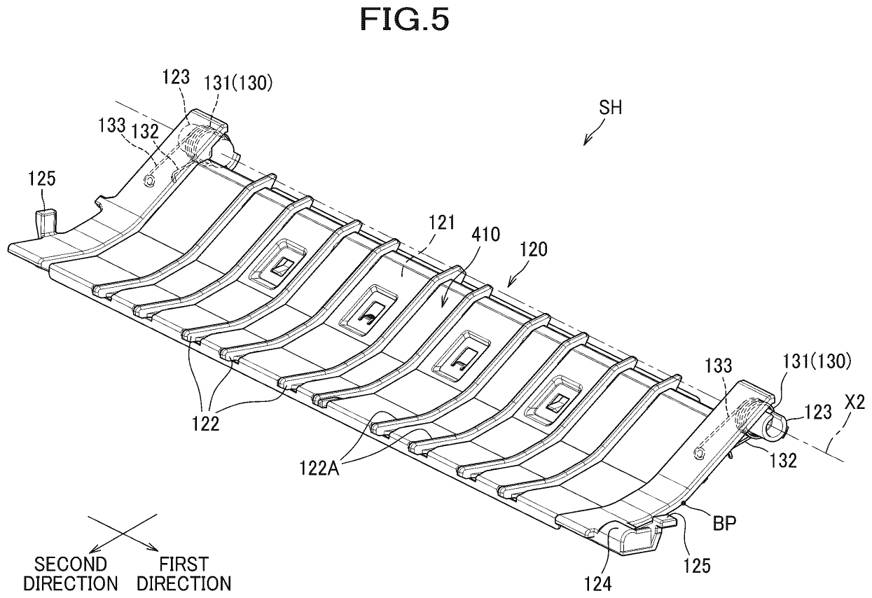

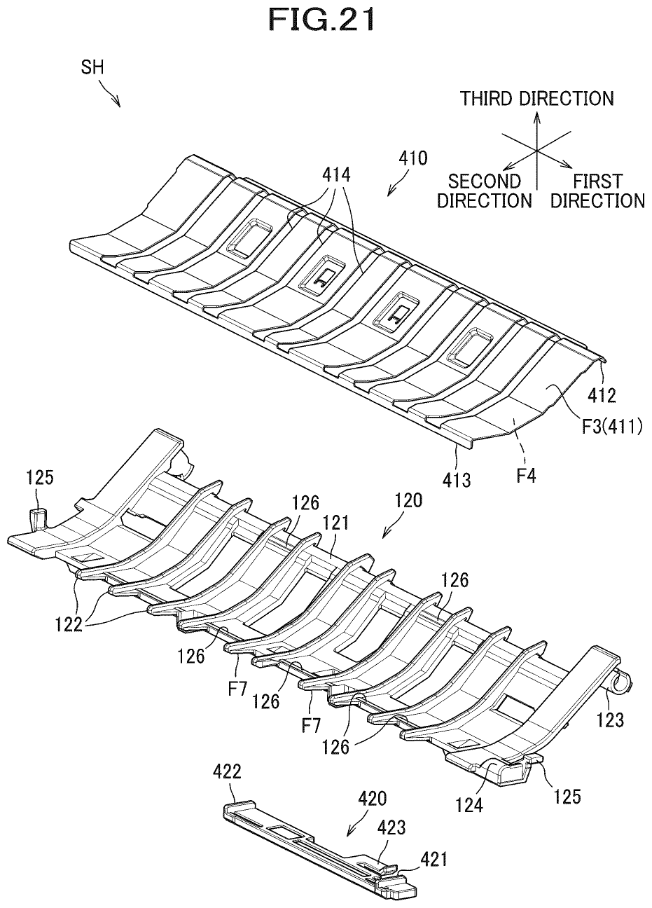

As shown in FIG. 5, the movable chute SH comprises a chute body 120, a metal plate 410, and an attachment member 420 shown in FIG. 21. The attachment member 420 is a member for attaching the metal plate 410 to the chute body 120. The structure and method for attaching the metal plate 410 to the chute body 120 will be described afterwards.

The chute body 120 includes a base portion 121, a plurality of guide ribs 122, tubular portions 123, a to-be-pushed portion 124, and stoppers 125.

The base portion 121 has a curved plate shape that is concave downward as viewed in the first direction. The base portion 121 extends in the first direction and the second direction.

The plurality of guide ribs 122 protrude upward from the base portion 121 and extend along the curve of the base portion 121 in the second direction. The top surfaces of the plurality of guide ribs 122 form guide surfaces 122A for guiding the sheet S.

The tubular portions 123 are located at a side of the base portion 121 on the other side in the second direction. One tubular portion 123 is provided on each end of the movable chute SH in the first direction. Each tubular portion 123 is formed in a shape of a hollow cylinder with a center on the rotation axis X2. The tubular portions 123 are rotatably supported by the base portion 110.

The to-be-pushed portion 124 is located at an end of the movable chute SH on the one side in the first direction and at a side of the movable chute SH on the one side in the second direction. The to-be-pushed portion 124 protrudes upward from the base portion 121. The to-be-pushed portion 124 is a portion that is pushed by a linkage 200, which will be described below, when the movable chute SH moves from the first position to the second position.

The stoppers 125 contact a duct DU, which will be described below, to restrict upward movement of the movable chute SH. The stoppers 125 are located between the tubular portions 123 and the to-be-pushed portion 124 in the second direction. One stopper 125 is located at each end of the movable chute SH in the first direction.

The spring 130 is a torsion spring. The spring 130 is located at both ends of the movable chute SH in the first direction. The spring 130 includes a coil 131, a first arm 132, and a second arm 133. The coil 131 is engaged with an outside surface of the tubular portion 123. The first arm 132 extends from the coil 131 and is hooked onto the base portion 110. The second arm 133 extends from the coil 131 and is hooked onto the movable chute SH. The spring 130 constantly biases the movable chute SH upward. That is, the spring 130 biases the movable chute SH toward the first position. Thus, when the movable chute SH is not pushed by the linkage 200, the movable chute SH is pushed upward by the spring 130 until the stopper 125 contacts the duct DU and is located in the first position.

As shown in FIG. 2, the image forming apparatus 1 further comprises an exhaust fan FA, a duct DU, and a movement device TM.

The exhaust fan FA is capable of exhausting air inside the main housing 2 to the outside of the main housing 2.

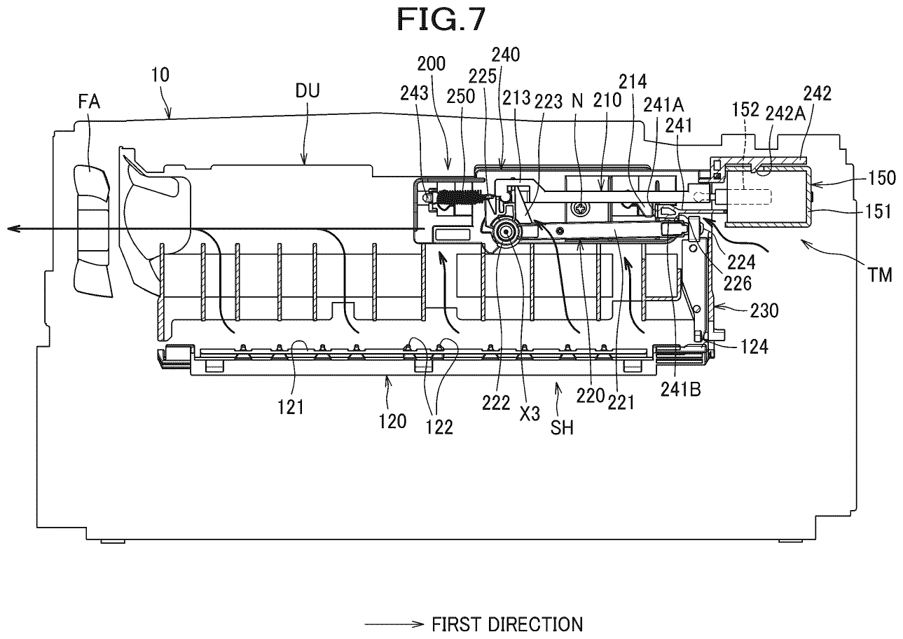

The duct DU is a member that guides the air inside the main housing 2 to the exhaust fan FA to exhaust the air inside the main housing 2 to the outside of the main housing 2. Specifically, the duct DU guides the air inside the main housing 2 from the one side to the other side in the first direction (see FIG. 7). The duct DU extends in the first direction. The duct DU overlaps the movable chute SH as viewed in the up-down direction.

The movement device TM is a device for moving the movable chute SH. As shown in FIG. 7, the movement device TM comprises a solenoid actuator 150 and a linkage 200. The solenoid actuator 150 is located at an end of the duct DU on the one side in the first direction. The exhaust fan FA is located at an end of the duct DU on the other side in the first direction. In other words, the duct DU is located between the exhaust fan FA and the solenoid actuator 150.

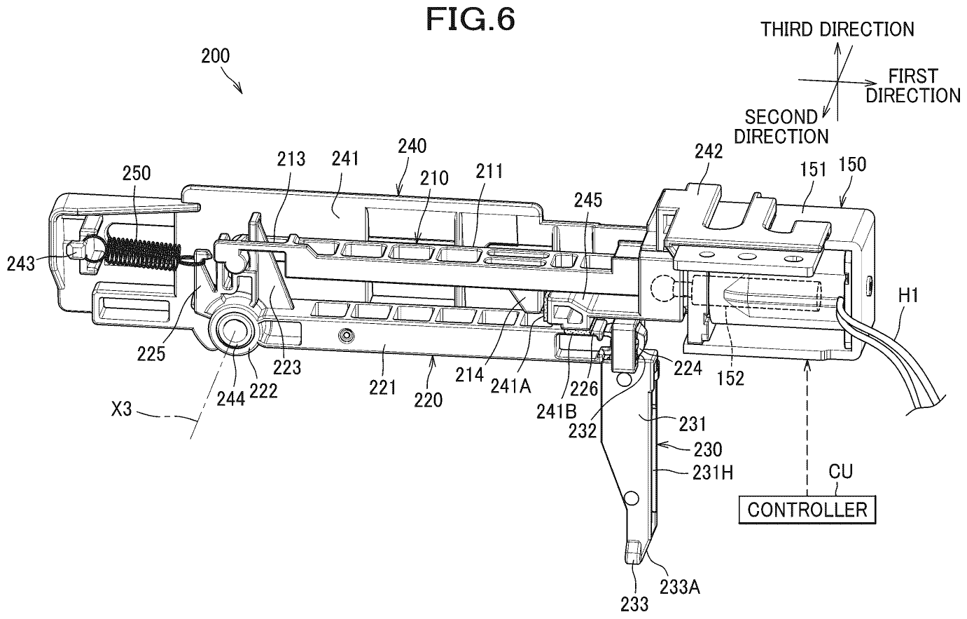

As shown in FIG. 6, the solenoid actuator 150 comprises a main body 151 and a movable portion 152. The image forming apparatus 1 further comprises a controller CU.

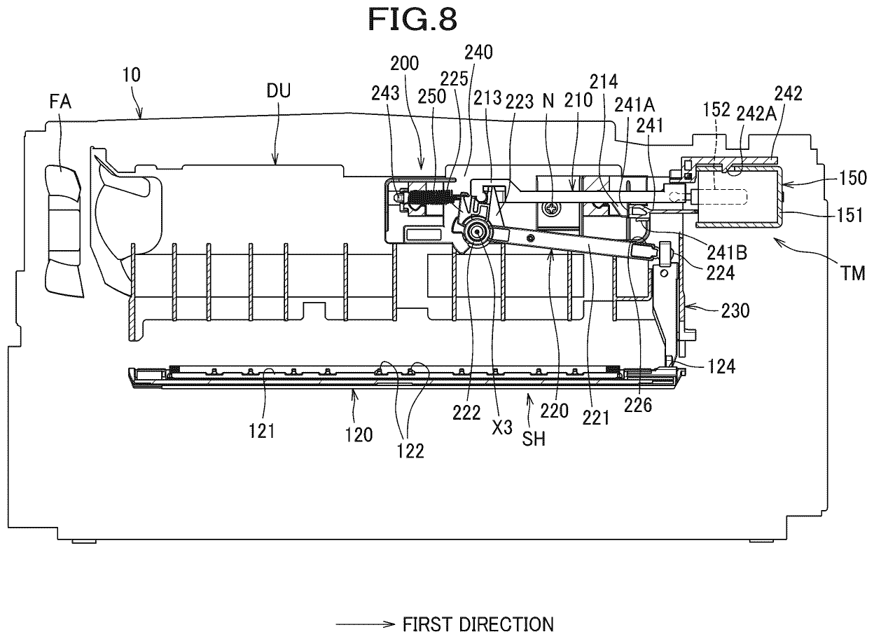

The main body 151 has a rectangular parallelepiped shape. The movable portion 152 is a pin that moves relative to the main body 151 and is slidable in the first direction. The movable portion 152 is movable between a forward position shown in FIG. 7 and a retracted position shown in FIG. 8. The movable portion 152 is located in the forward position when an ON signal is not transmitted from the controller CU. When an ON signal is transmitted from the controller CU, the movable portion 152 is pulled by an electromagnetic force and moves from the forward position to the retracted position on the one side in the first direction. When an ON signal is no longer transmitted from the controller CU, the movable portion 152 is returned to the forward position by the biasing force of the coil spring 250 which will be described below. When the movable portion 152 is located in the forward position, the movable chute SH is located in the first position. When the movable portion 152 is located in the retracted position, the movable chute SH is located in the second position.

The linkage 200 is a mechanism that is moved by a driving force of the solenoid actuator 150. The linkage 200 comprises a first link 210, a second link 220, a third link 230, a holder 240, and a coil spring 250.

The holder 240 holds a part of the linkage 200. The holder 240 is supported by the duct DU while holding the linkage 200. The holder 240 includes a base portion 241, an extension portion 242, a first hook 243, a boss 244, and a contact portion 245.

The base portion 241 extends in the first direction. The extension portion 242 extends upward and toward the one side in the first direction from an end of the base portion 241 on the one side in the first direction. The extension portion 242 covers a part of an upper side of the main body 151 of the solenoid actuator 150. As shown in FIG. 7, the extension portion 242 includes an engagement pawl 242A protruding downward from the extension portion 242. The engagement pawl 242A is engaged with an upper surface of the main body 151 of the solenoid actuator 150. The holder 240 is thereby located in place relative to the solenoid actuator 150 in the first direction.

The first hook 243 is located at an end of the base portion 241 on the other side in the first direction. The first hook 243 is engaged with one end of the coil spring 250.

The boss 244 is located at the end of the base portion 241 on the other side in the first direction. The boss 244 is a hollow cylindrical projection that protrudes from the base portion 241 toward the one side in the second direction. The boss 244 supports the second link 220 in a manner that allows the second link 220 to rotate.

The contact portion 245 is located between the extension portion 242 and the boss 244 in the first direction. The contact portion 245 is a projection protruding from the base portion 241 toward the one side in the second direction. The contact portion 245 has a first contact surface 241A and a second contact surface 241B. The first contact surface 241A and the second contact surface 241B each has a sponge affixed thereon. Each sponge is configured to flatten to a predetermined thickness when pressure is applied from the first link 210 or the second link 220.

The first contact surface 241A faces the other side in the first direction. The first contact surface 241A contacts the first link 210 via the sponge as the movable portion 152 moves from the forward position to the retracted position.

The second contact surface 241B faces downward. The second contact surface 241B contacts the second link 220 via the sponge as the movable portion 152 moves from the retracted position to the forward position.

The first link 210 is a member that is connected to the movable portion 152 of the solenoid actuator 150 and slides in the first direction together with the movable portion 152 as the movable portion 152 moves in the first direction. The first link 210 extends in the first direction. The first link 210 has a base portion 211, a first hole 213, and a first protrusion 214.

The base portion 211 is shaped as a rectangular rod extending in the first direction. One end of the base portion 211 on the one side in the first direction is connected to the distal end of the movable portion 152 of the solenoid actuator 150. As a result, as the movable portion 152 moves in the first direction, the first link 210 also moves in the first direction along with the movable portion 152.

The first hole 213 is located at an end of the base portion 211 on the other side in the first direction. The first hole 213 is a rectangular hole extending through the base portion 211 in the up-down direction.

The first protrusion 214 extends downward from an end of the base portion 211 on the one side in the first direction. The first protrusion 214 is located further toward the one side in the first direction than a central portion of the base portion 211 in the first direction. The first protrusion 214 is a portion that contacts the first contact surface 241A of the holder 240 via the sponge as the movable portion 152 moves from the forward position to the retracted position.

The second link 220 is a member that is connected to the first link 210 and rotates about the first axis X3 as its center of rotation as the first link 210 moves in the first direction. The second link 220 is located below the first link 210. The second link 220 comprises a base portion 221, a hollow cylindrical portion 222, a second protrusion 223, a third protrusion 224, a second hook 225, and a third contact surface 226.

The base portion 221 is shaped as a rectangular rod extending in the first direction. The hollow cylindrical portion 222 is located at an end of the base portion 221 on the other side in the first direction. The hollow cylindrical portion 222 is shaped as a hollow cylinder. The boss 244 of the holder 240 is located inside the hollow cylindrical portion 222. With the boss 244 located inside the hollow cylindrical portion 222, the second link 220 is allowed to rotate about the first axis X3.

The second protrusion 223 protrudes upward from an outer peripheral surface of the hollow cylindrical portion 222. The second protrusion 223 is located in the first hole 213 of the first link 210. The second link 220 is thereby connected to the other end of the first link 210 and is allowed to rotate about the first axis X3 in response to movement of the first link 210. Specifically, as the first link 210 moves toward the one side in the first direction, the first link 210 pushes the second protrusion 223 toward the one side in the first direction causing the second link 220 to rotate in the clockwise direction of FIG. 6.

The third protrusion 224 protrudes from an end of the base portion 221 on the one side in the first direction toward the one side in the first direction. The third protrusion 224 is connected to the third link 230.

The second hook 225 protrudes upward from the outer peripheral surface of the hollow cylindrical portion 222. The second hook 225 is located further toward the other side in the first direction than the second protrusion 223. The second hook 225 is engaged with the other end of the coil spring 250.

The third contact surface 226 is located on an upper side of the end of the base portion 221 on the one side in the first direction. The third contact surface 226 contacts the second contact surface 241B via the sponge as the second link 220 rotates and moves upward in the counter-clockwise direction of FIG. 6. Once the third contact surface 226 contacts the second contact surface 241B, the second link 220 does not rotate any further.

The third link 230 is a member that is connected to the second link 220 and slides upward or downward when the second link 220 rotates, in response to an upward or downward movement of the third protrusion 224 of the second link 220. Specifically, the third link 230 is movable between a pushing position and an allowing position as the second link 220 rotates. The pushing position is a position in which the third link 230 pushes the movable chute SH downward to the second position. The allowing position is a position in which the third link 230 does not push the movable chute SH downward and the movable chute SH is allowed to be located in the first position. The third link 230 extends in the up-down direction and is located below the second link 220. The third link 230 comprises a base portion 231, a third hole 232, and a chute pushing portion 233.

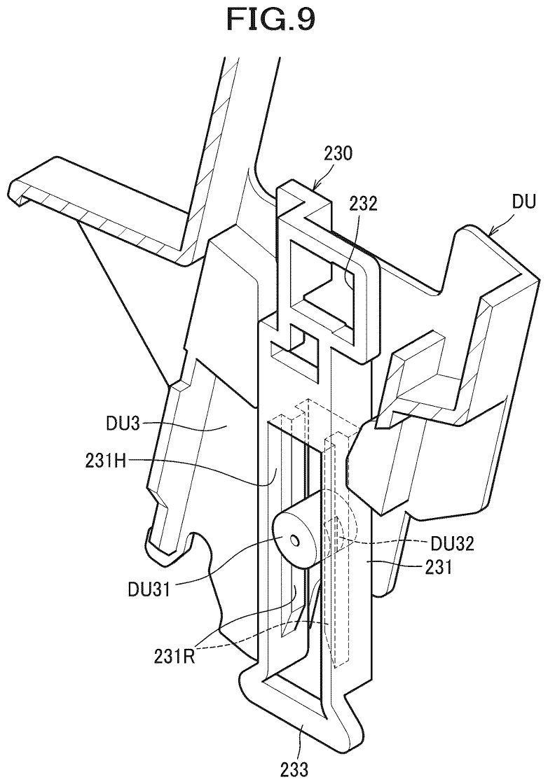

The base portion 231 is shaped as a rectangular rod extending in the up-down direction. As shown in FIG. 9, the base portion 231 has a base hole 231H and rails 231R. The base hole 231H is a rectangular hole formed in the base portion 231. The base hole 231H extends in the up-down direction and through the base portion 231 in the first direction. The rails 231R extend in the up-down direction and are respectively formed on inner walls of the base portion 231 on both sides of the base hole 231H. The rails 231R are engaged with a groove DU32 formed on a projection DU31 of the duct DU. The rails 231R engaged with the groove DU32 allow the third link 230 to slide in the up-down direction.

The third hole 232 is a rectangular hole located at an upper end of the third link 230. As shown in FIG. 6, the third hole 232 receives the third protrusion 224 of the second link 220. The third link 230 thereby slides upward or downward as the second link 220 rotates.

The chute pushing portion 233 has a pushing surface 233A that pushes the movable chute SH downward. The pushing surface 233A pushes the movable chute SH from a guide-surface 122A side thereof, i.e., an upper side thereof. The chute pushing portion 233 is located at a lower end of the third link 230. The chute pushing portion 233 contacts the to-be-pushed portion 124 of the movable chute SH and pushes the movable chute SH downward when the third link 230 moves downward.

The coil spring 250 is an extension spring that constantly pulls the second link 220 toward the other side in the first direction. The coil spring 250 constantly pulls the first link 210 via the second link 220 toward the other side in the first direction.

As shown in FIG. 7, the movable portion 152 is located in the forward position when an ON signal is not transmitted from the controller CU. When an ON signal is transmitted from the controller CU, the movable portion 152 is pulled and moves from the forward position to the retracted position. As shown in FIG. 8, as the movable portion 152 moves from the forward position to the retracted position, the first link 210 slides together with the movable portion 152 toward the one side in the first direction. As the first link 210 slides toward the one side in the first direction, the second protrusion 223 of the second link 220 is pushed by the first link 210 toward the one side in the first direction. As the second protrusion 223 is pushed toward the one side in the first direction, the second link 220 rotates in the clockwise direction of FIG. 8. As the second link 220 rotates in the clockwise direction, the third protrusion 224 pushes the third link 230 downward. As the third link 230 is pushed downward, the third link 230 pushes the to-be-pushed portion 124 of the movable chute SH downward. The movable chute SH thereby moves from the first position to the second position.

On the other hand, when an ON signal is no longer transmitted from the controller CU, the second link 220 is rotated in the counter-clockwise direction from the state shown in FIG. 8 by the biasing force of the coil spring 250. As the second link 220 rotates in the counter-clockwise direction, the third link 230 is pulled upward by the third protrusion 224 of the second link 220 as shown in FIG. 7. As the third link 230 is pulled upward, the third link 230 moves from the pushing position to the allowing position so that the chute pushing portion 233 does not push the to-be-pushed portion 124 of the movable chute SH. When the third link 230 moves to the allowing position, the movable chute SH is moved from the second position to the first position by the biasing force of the spring 130. As the second link 220 rotates in the counter-clockwise direction, the first link 210 is pulled toward the other side in the first direction by the second protrusion 223 of the second link 220. As the first link 210 is pulled toward the other side in the first direction, the movable portion 152 is pulled, together with the first link 210, toward the other side in the first direction and returns to the forward position.

The controller CU comprises a central processing unit (CPU), a random-access memory (RAM), a read-only memory (ROM), an input/output circuit, etc., and performs various arithmetic processing based on programs and/or data stored in the ROM or other components to execute control. In this embodiment, the controller CU controls the solenoid actuator 150 to move the movable chute SH only between the first position and the second position. Specifically, the controller CU turns off the solenoid actuator 150 before a leading edge of a sheet S reaches the fixing device 6, each time an image is formed on a sheet S, to locate the movable chute SH in the first position. The controller CU turns on the solenoid actuator 150 after a leading edge of a sheet S reaches the fixing device 6, each time an image is formed on a sheet S, to move the movable chute SH from the first position shown in FIG. 2 to the second position shown in FIG. 3.

Specifically, while printing control is not being executed, the controller CU turns off the solenoid actuator 150 to locate the movable chute SH in the first position. After a printing command is received and the leading edge of a sheet S reaches the fixing device 6, the controller CU turns on the solenoid actuator 150 to move the movable chute SH to the second position.

After execution of printing control ends, the controller CU turns off the solenoid actuator 150 to move the movable chute SH to the first position. In the case where a plurality of sheets S are to be printed, the controller CU repeats the above described operation for each sheet S. When it is determined that a sheet S is jammed during conveyance of the sheet S, the controller CU turns off the solenoid actuator 150 to locate the movable chute SH in the first position. Determination that the sheet S is jammed may, for example, be made by a signal from a sheet sensor for detecting presence or absence of a sheet S.

Since the movable portion 152 of the solenoid actuator 150 only moves between the forward position and the retracted position, the controller CU cannot move the movable chute SH from the second position to the third position. However, the movable chute SH can be manually moved from the second position to the third position.

Specifically, when the movable chute SH is located in the first position, the movable chute SH is in contact with the duct and thus cannot be moved upward but can be moved downward. When the movable chute SH is located in the second position, the movable chute SH is in contact with the linkage 200 and thus cannot be moved upward but can be moved downward. Further, when the movable chute SH is located in the third position, the movable chute SH is in contact with the base portion 110 of the guide member 100 and thus cannot be moved downward but can be moved upward.

In the present embodiment, the movable chute SH is located in the first position when the controller CU is not executing printing control. Thus, when a jam removal process is performed to remove a sheet S jammed in the image forming apparatus 1, the movable chute SH is movable from the first position toward the third position by a user's operation. Since the movable chute SH is not connected to the movement device TM and the movable chute SH is configured such that the upper surface thereof merely contacts the movement device TM, the movable chute SH is movable in a direction from the first position toward the third position in a state where the movement device TM is not actuated.

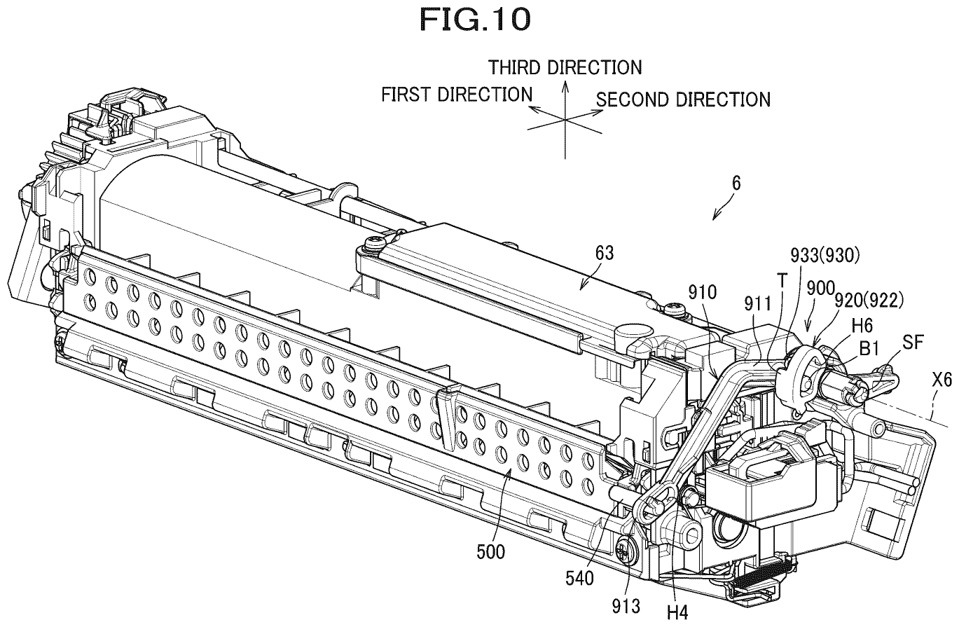

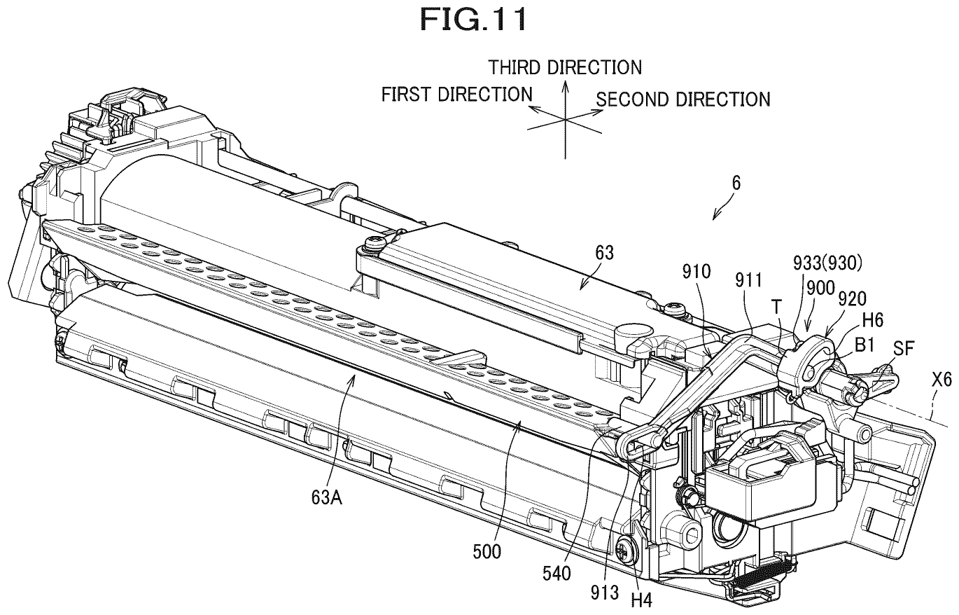

As shown in FIGS. 10 and 11, the fixing device 6 further comprises a fixing shutter 500 for covering/uncovering an opening 63A of the fixing housing 63 and a shutter actuation mechanism 900 for opening/closing the fixing shutter 500. The opening 63A of the fixing housing 63 is an opening through which a sheet S being conveyed toward the fixing nip NP2 passes. The opening 63A is located upstream of the fixing nip NP2 in the conveyance direction.

The fixing shutter 500 is rotatable between a closed position shown in FIG. 10 and an open position shown in FIG. 11. The fixing shutter 500 in the closed position covers the opening 63A. The fixing shutter 500 in the open position uncovers the opening 63A. The fixing shutter 500 is rotatably supported by the fixing housing 63 at both ends in the first direction. The fixing shutter 500 has a projection 540 at an end thereof on the other side in the first direction. The projection 540 is located in a position different from a position of a center of rotation of the fixing shutter 500.

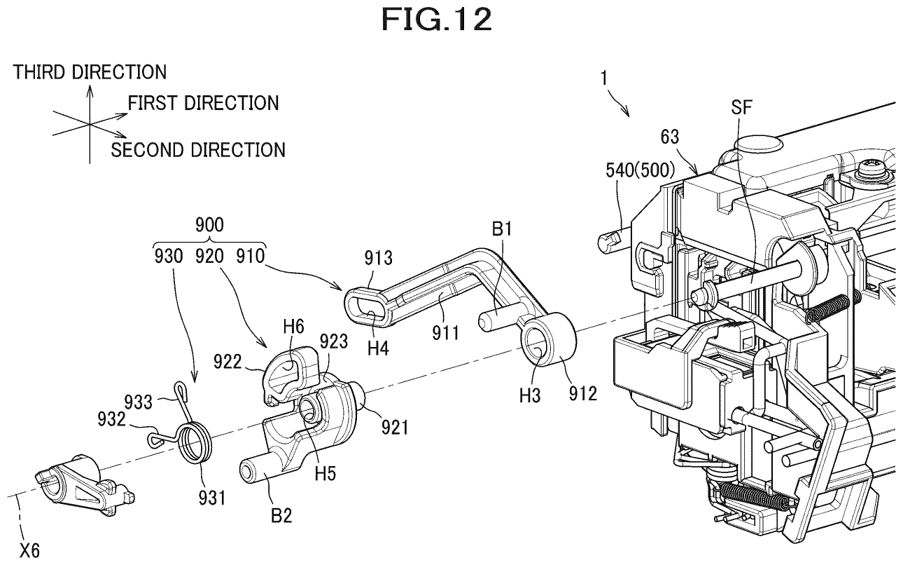

As shown in FIG. 12, the shutter actuation mechanism 900 comprises a shutter arm 910, an arm cam 920, and a spring 930. The shutter arm 910 and the arm cam 920 are made of plastic or the like. The spring 930 is made of metal or the like.

The shutter arm 910 rotates about an arm axis X6 and thereby performs a function of rotating the fixing shutter 500 between the closed position and the open position (see FIGS. 10 and 11). The shutter arm 910 includes an arm body 911, a first connection portion 912, and a second connection portion 913. The arm body 911, the first connection portion 912, and the second connection portion 913 are integrally formed in one piece.

The first connection portion 912 has a hole H3 in which a hollow cylindrical portion 921 of the arm cam 920 is received. The first connection portion 912 is rotatably supported by a shaft SF via the hollow cylindrical portion 921. The shaft SF is supported by the fixing housing 63.

The second connection portion 913 has an elongated hole H4 in which the projection 540 of the fixing shutter 500 is received. The second connection portion 913 is connected to the projection 540 of the fixing shutter 500 at the elongated hole H4.

The arm body 911 connects the first connection portion 912 and the second connection portion 913. The arm body 911 includes a boss B1 protruding toward the other side in the first direction.

The arm cam 920 is a cam that rotates about the arm axis X6 to push the shutter arm 910 at a position offset from the arm axis X6, and causes the shutter arm 910 to rotate about the arm axis X6. Specifically, the arm cam 920 pushes the boss B1 of the shutter arm 910 in a circumferential direction. Herein, the circumferential direction is a direction along a circle with a center on the arm axis X6. The arm cam 920 includes a hollow cylindrical portion 921, a pressing portion 922, a boss B2, and a connection portion 923. The hollow cylindrical portion 921, the pressing portion 922, the boss B2, and the connection portion 923 are integrally formed in one piece. The pressing portion 922 and the boss B2 are connected to the hollow cylindrical portion 921 by the connection portion 923.

The hollow cylindrical portion 921 has a hole H5 in which the shaft SF is received. The hollow cylindrical portion 921 is rotatably supported by the shaft SF. The hollow cylindrical portion 921 is received in the hole H3 of the shutter arm 910. The hollow cylindrical portion 921 supports the shutter arm 910 in a manner that allows the shutter arm 910 to rotate.

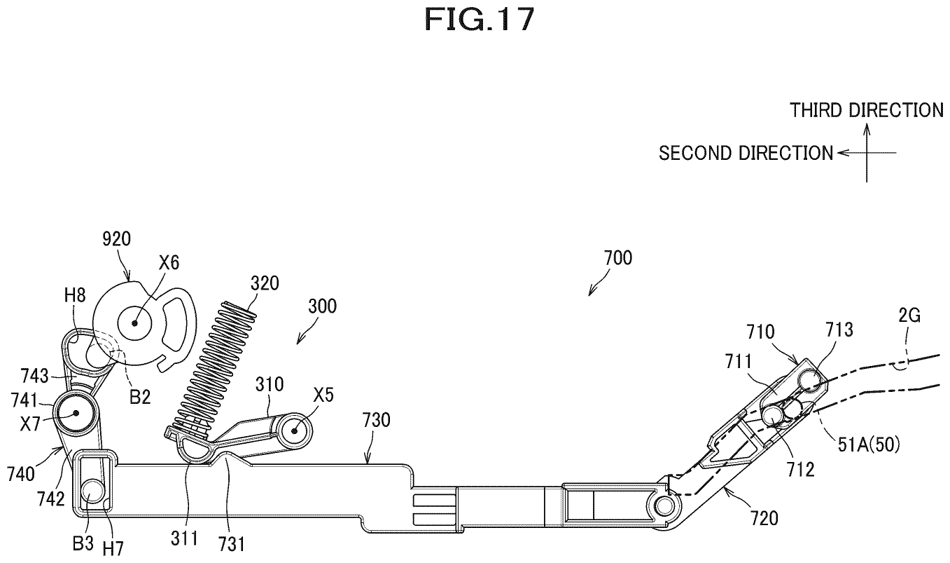

The boss B2 is a part to which a force is input from a connection link 700 (see FIG. 17) which will be described below. The boss B2 is located in a position different from a position of the arm axis X6 in a direction perpendicular to the first direction. The boss B2 protrudes toward the other side in the first direction.

The pressing portion 922 is located at a position offset from the arm axis X6. The pressing portion 922 has an elongated hole H6 in which the boss B1 of the shutter arm 910 is received. The elongated hole H6 is formed in a shape of an arc with a center on the arm axis X6. The elongated hole H6 allows displacement of the boss B1 of the shutter arm 910. The pressing portion 922 is a tubular portion that contours the arc-shaped elongated hole H6. As shown in FIG. 10, the pressing portion 922 has an end on the one side in the first direction of which a portion of the tubular portion defining one side of the elongated hole H6 is cut off to form a spring contact portion T contactable with the spring 930 in directions of rotation of the arm cam 920.

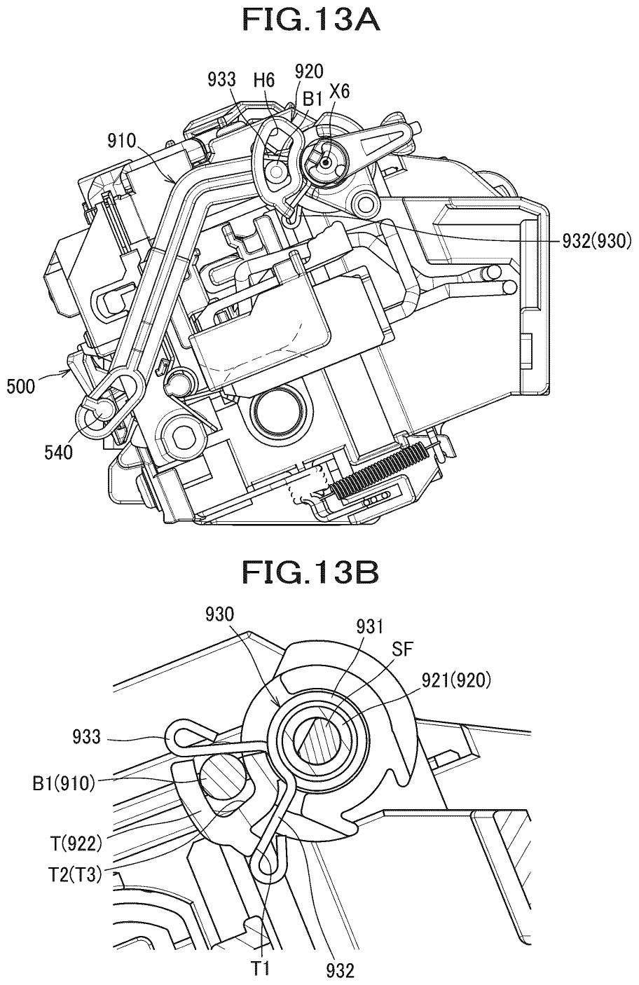

As shown in FIG. 13B, the spring 930 is a torsion spring including a coil 931, a first arm 932, and a second arm 933. The hollow cylindrical portion 921 of the arm cam 920 is located inside the coil 931. The hollow cylindrical portion 921 supports the coil 931. The first arm 932 and the second arm 933 form an acute angle.

The spring contact portion T is located between the first arm 932 and the second arm 933. The spring contact portion T has a first contact surface T1 and a recess T3. The first contact surface T1 is a surface contactable with the first arm 932 in a direction of rotation of the arm cam 920.

The recess T3 has a shape formed by cutting off a part of the elongated hole H6 shown in FIG. 13A. The recess T3 opens toward the second arm 933. The boss B1 of the shutter arm 910 is movable in the recess T3. A bottom of the recess T3 forms a second contact surface T2 contactable with the boss B1 of the shutter arm 910 in a direction of rotation of the arm cam 920. The second contact surface T2 is located between the first contact surface T1 and the boss B1 in the direction of rotation of the arm cam 920. The boss B1 is located between the second contact surface T2 and the second arm 933 in the direction of rotation of the arm cam 920.

When the fixing shutter 500 is in the closed position as shown in FIG. 13A, the first contact surface T1 of the arm cam 920 contacts the first arm 932 and the second arm 933 contacts the boss B1 of the shutter arm 910 as shown in FIG. 13B. The position at which the second arm 933 contacts the boss B1 of the shutter arm 910 is a position offset from the arm axis X6. The arm cam 920 thereby pushes the shutter arm 910 via the spring 930 to locate the fixing shutter 500 in the closed position.

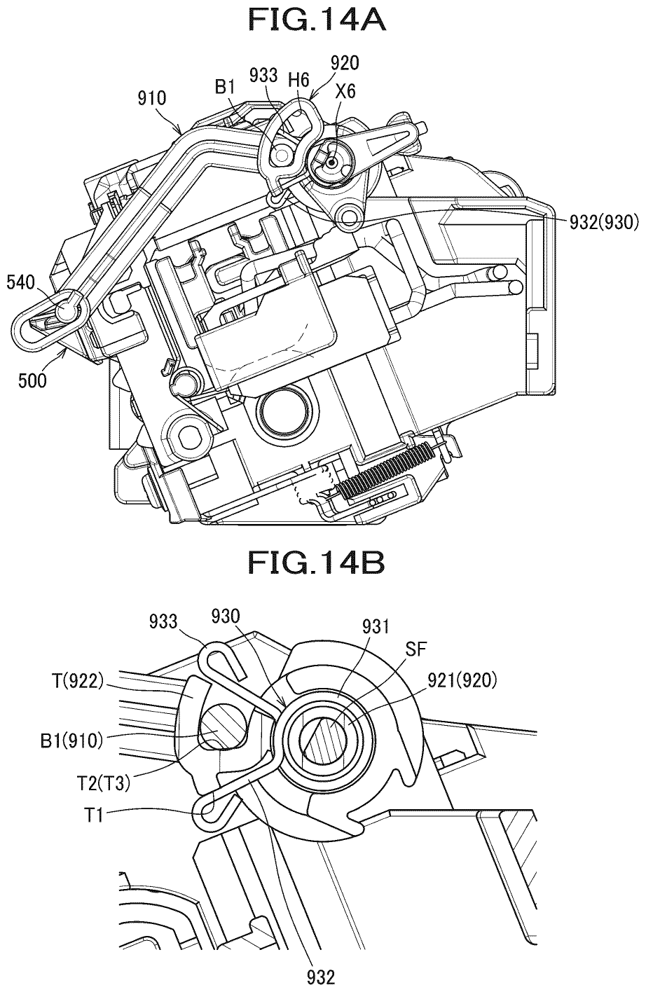

When the fixing shutter 500 is in the open position as shown in FIG. 14A, the second contact surface T2 of the arm cam 920 contacts the boss B1 of the shutter arm 910 as shown in FIG. 14B. The position at which the second contact surface T2 contacts the boss B1 of the shutter arm 910 is a position offset from the arm axis X6. The arm cam 920 thereby contacts the shutter arm 910 to locate the fixing shutter 500 in the open position.

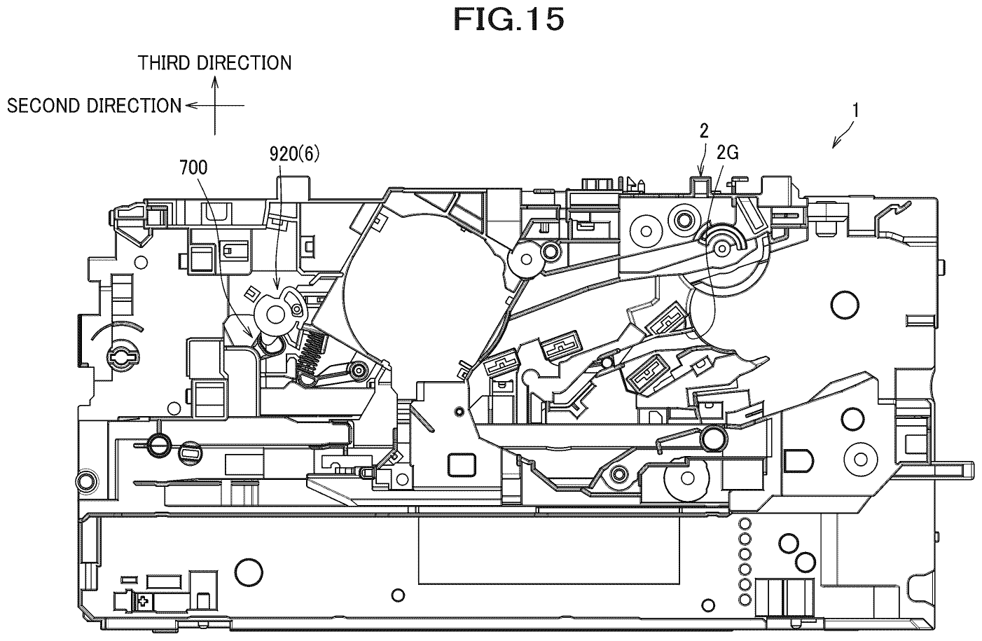

As shown in FIGS. 15 and 17, the image forming apparatus 1 further comprises a connection link 700. In FIG. 15, the arm cam 920 of the fixing device 6 is illustrated to show the position of the fixing device 6 and the other portions of the fixing device 6 are omitted.

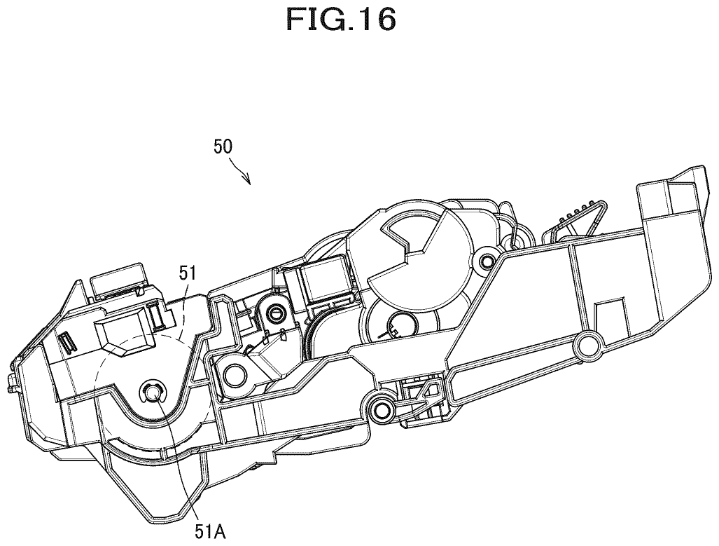

As shown in FIG. 16, the photosensitive drum 51 comprises a drum shaft 51A. The drum shaft 51A is located at the center of rotation of the photosensitive drum 51. As shown in FIG. 15, the main housing 2 includes a guide rail 2G for guiding the drum shaft 51A in a process of the process cartridge 50 being installed into and removed from the main housing 2.

As shown in FIG. 17, the connection link 700 is a mechanism that causes the fixing shutter 500 to rotate from the closed position to the open position in a process of the process cartridge 50 being installed into the main housing 2, and causes the fixing shutter 500 to rotate from the open position to the closed position in the process of the process cartridge 50 being removed from the main housing 2. The connection link 700 comprises an abutment piece 710, a first rotation link 720, a translation link 730, and a second rotation link 740.

The abutment piece 710 is movable when contacted by the drum shaft 51A. The abutment piece 710 is movably supported by an abutment piece rail (not shown). The abutment piece rail is provided on the main housing 2 or other components of the image forming apparatus 1.

The abutment piece 710 includes a body portion 711, a first projection 712, and a second projection 713. The first projection 712 and the second projection 713 protrude from the body portion 711 in the first direction.

The first projection 712 contacts the drum shaft 51A when the process cartridge 50 is installed into the main housing 2. The second projection 713 contacts the drum shaft 51A when the process cartridge 50 is removed from the main housing 2.

Although the abutment piece 710 is configured to move when contacted by the drum shaft 51A in this embodiment, a guide protrusion other than the drum shaft 51A may be formed on the process cartridge 50 and the abutment piece 710 may be configured to move when contacted by the guide protrusion.

The first rotation link 720 is a member having an approximately linear shape and connected to the abutment piece 710 and the translation link 730. One end of the first rotation link 720 supports the body portion 711 of the abutment piece 710 in a manner that allows the abutment piece 710 to rotate.

The translation link 730 is a member having an approximately linear shape and connected to the first rotation link 720 and the second rotation link 740. The translation link 730 is movable in a front-rear direction relative to the main housing 2. One end of the translation link 730 supports the first rotation link 720 in a manner that allows the first rotation link 720 to rotate. The other end of the translation link 730 has an elongated hole H7 elongated in the up-down direction.

The second rotation link 740 is connected to the translation link 730 and is supported by the main housing 2 in a manner rotatable about a link axis X7. The second rotation link 740 includes a support portion 741, a first arm 742, and a second arm 743. The support portion 741 is rotatably supported by the main housing 2. The first arm 742 extends approximately downward from the support portion 741. The second arm 743 extends approximately upward from the support portion 741.

The first arm 742 includes a boss B3 received in the elongated hole H7 of the translation link 730. The second arm 743 has an elongated hole H8. The elongated hole H8 is formed in a shape of an arc with a center on the link axis X7.

The boss B2 of the arm cam 920 is received in the elongated hole H8 of the second rotation link 740. Accordingly, a force input to the abutment piece 710 is transferred to the arm cam 920 via the first rotation link 720, the translation link 730, and the second rotation link 740.

The image forming apparatus 1 further comprises a lock 300 for keeping the fixing shutter 500 in the open position or the closed position. Specifically, the lock 300 presses the translation link 730 to restrain movement of the translation link 730 in the second direction. The lock 300 comprises a lock arm 310 in contact with the translation link 730, and a lock spring 320 that biases the lock arm 310 toward the translation link 730.

The lock arm 310 is supported by the main housing 2 in a manner rotatable about a lock axis X5. The translation link 730 includes a link projection 731 protruding toward the lock 300. The distal end 311 of the lock arm 310 is able to travel over the link projection 731 against the biasing force of the lock spring 320, as the translation link 730 moves in the second direction.

When the distal end 311 of the lock arm 310 is located at a side of the link projection 731 on the one side in the second direction, the translation link 730 is restrained from moving toward the one side in the second direction. When the distal end 311 of the lock arm 310 is located at a side of the link projection 731 on the other side in the second direction, the translation link 730 is restrained from moving toward the other side in the second direction.

Next, the operation of the shutter actuation mechanism 900 and the connection link 700 will be described.

First of all, the operation of the shutter actuation mechanism 900 and the connection link 700 as performed when the process cartridge 50 is being installed into the main housing 2 will be described. In the following description, the position of the arm cam 920 when the fixing shutter 500 is located in the closed position is also referred to as “close-corresponding-position”, and the position of the arm cam 920 when the fixing shutter 500 is located in the open position is also referred to as “open-corresponding-position”.

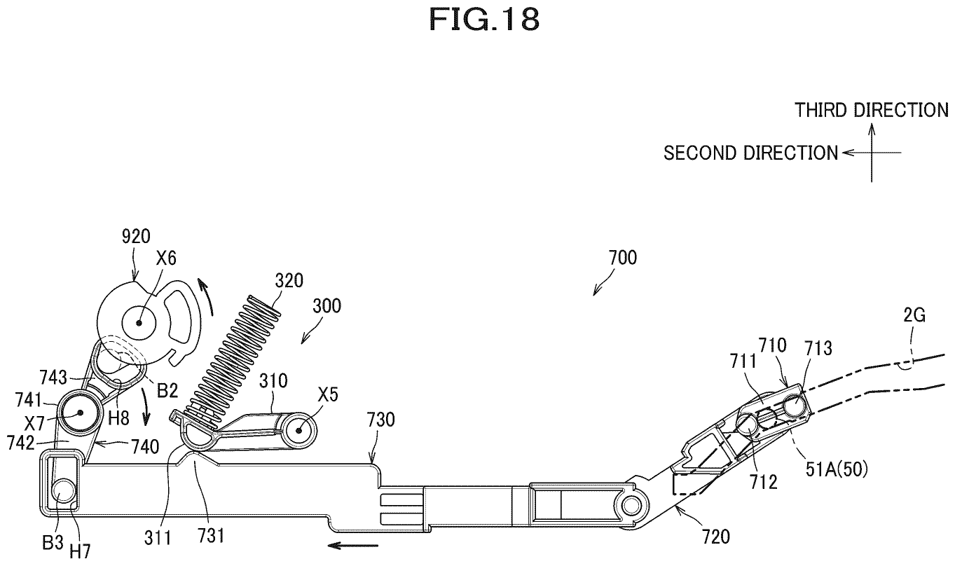

As shown in FIG. 17, as the drum shaft 51A of the process cartridge 50 is inserted into the guide rail G2 of the main housing 2, the drum shaft 51A contacts the first projection 712 of the abutment piece 710 and pushes the abutment piece 710 toward the one side in the second direction. As shown in FIG. 18, the force applied from the drum shaft 51A to the abutment piece 710 is thereby transmitted to the second rotation link 740 via the first rotation link 720 and the translation link 730, so that the second rotation link 740 rotates in the clockwise direction of the drawings.

When the second rotation link 740 rotates in the clockwise direction of the drawings, the second rotation link 740 pushes the boss B2 of the arm cam 920, so that the arm cam 920 rotates from the close-corresponding-position to the open-corresponding-position.

In the process of the arm cam 920 rotating from the close-corresponding-position to the open-corresponding-position, the second contact surface T2 of the arm cam 920 pushes the boss B1 of the shutter arm 910 as shown in FIG. 14B, so that the shutter arm 910 rotates from the position shown in FIG. 13A to the position shown in FIG. 14A. The fixing shutter 500 connected to the shutter arm 910 thereby rotates from the closed position to the open position.

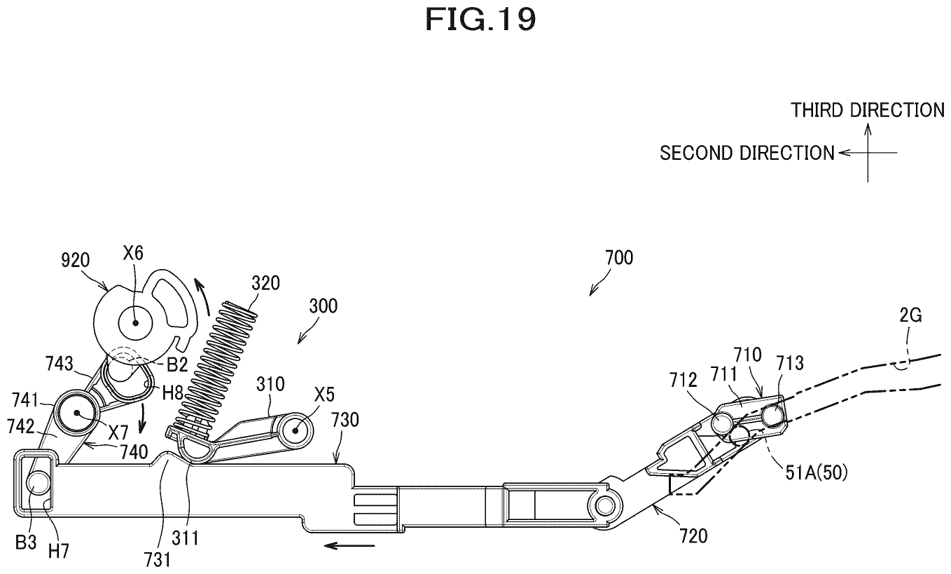

As shown in FIG. 19, as the process cartridge 50 installed in the main housing 2 is removed from the main housing 2, the drum shaft 51A moves along the guide rail 2G, contacts the second projection 713 of the abutment piece 710, and pushes the abutment piece 710 toward the other side in the second direction. A force applied from the drum shaft 51A to the abutment piece 710 is thereby transmitted to the second rotation link 740 via the first rotation link 720 and the translation link 730, so that the second rotation link 740 rotates in the counter-clockwise direction of the drawings.

When the second rotation link 740 rotates in the counter-clockwise direction of the drawings, the second rotation link 740 pushes the boss B2 of the arm cam 920, so that the arm cam 920 rotates from the open-corresponding-position to the close-corresponding-position.

In the process of the arm cam 920 rotating from the open-corresponding-position to the close-corresponding-position, the first contact surface T1 of the arm cam 920 pushes the boss B1 of the shutter arm 910 via the spring 930 as shown in FIG. 13B, so that the shutter arm 910 rotates from the position shown in FIG. 14A to the position shown in FIG. 13A. The fixing shutter 500 connected to the shutter arm 910 thereby rotates from the open position to the closed position.

Next, the action and advantageous effects of the movable chute SH obtained when a user performs a jam removal process will be described.

As shown in FIG. 1, when a sheet S gets jammed in the fixing device 6 during fixing, the controller CU turns off the solenoid actuator 150, so that the movable chute SH rotates from the second position to the first position. Subsequently, when the user opens the front cover 23 and removes the process cartridge 50 from the main housing 2, the fixing shutter 500 is rotated from the open position to the closed position by the connection link 700 shown in FIG. 19.

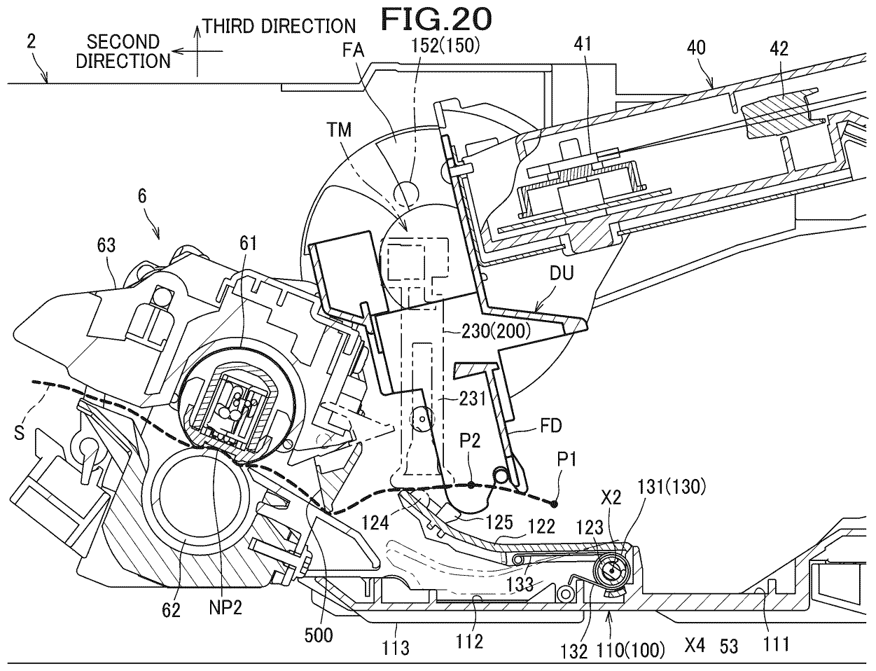

As shown in FIG. 20, if a trailing edge of the sheet S jammed in the fixing device 6 is located at an upstream position P1 that is upstream of a front surface FD of the duct DU in the conveyance direction, the sheet S is lifted upward by the distal end of the movable chute SH located in the first position which causes a space to be formed between the trailing edge of the sheet S and an upper surface of the movable chute SH. The user can thereby easily grasp the trailing edge of the sheet S and easily perform the jam removal process. Herein, the front surface FD of the duct DU is a surface opposed to the process cartridge 50 in the conveyance direction.

If the trailing edge of the sheet S jammed in the fixing device 6 is located at a downstream position P2 that is downstream of the front surface FD of the duct DU in the conveyance direction, the user pushes the movable chute SH downward from the first position to the third position. This causes the sheet S supported by the distal end of the movable chute SH to move down. Thus, the user can easily grasp the trailing edge of the sheet S and thereby easily perform the jam removal process.

Next the structure and method for attaching the metal plate 410 of the movable chute SH to the chute body 120 will be described in detail.

As described above and shown in FIG. 21, the movable chute SH comprises a chute body 120, a metal plate 410, and an attachment member 420.

The chute body 120 is made of a material including polyethylene terephthalate (PET) and glass fiber.

The metal plate 410 is made of metal.

The attachment member 420 is made of an acrylonitrile butadiene styrene resin (ABS resin).

The above-described material for the chute body 120 is more electrically conductive compared to ABS resins. Thus, since the chute body 120 is not easily charged when a charged sheet S contacts the chute body 120, electrical discharge between the chute body 120 and the sheet S will be restrained and an image on the sheet S will be kept from being distorted. However, the material of the chute body 120 has a lower rigidity than that of ABS resins. Therefore, the rigidity of the chute body 120 is increased by laying the metal plate 410 over the chute body 120.

The chute body 120 further comprises, in addition to the above-described base portion 121, guide ribs 122, etc., a plurality of ribs 126 that locate the metal plate 410 in place in the third direction.

The ribs 126 protrude upward from the base portion 121. The ribs 126 are provided on either an upstream end or a downstream end of the base portion 121 in the conveyance direction. The ribs 126 are each disposed between a corresponding pair of the guide ribs 122.

The guide ribs 122 of the chute body 120 protrude downstream and upstream from the base portion 121 in the conveyance direction.

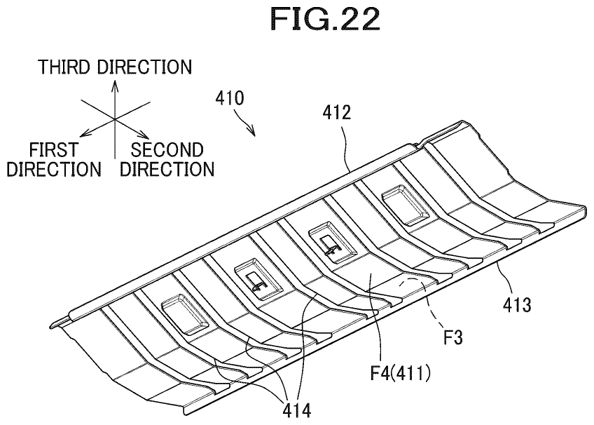

As shown in FIGS. 21 and 22, the metal plate 410 includes a base portion 411, an upstream flange 412, a downstream flange 413, and a plurality of slits 414.

The base portion 411 is curved to follow the curved base portion 121 of the chute body 120. The base portion 411 has a front surface F3 and a back surface F4.

The front surface F3 is located at an upper end of the base portion 411. The front surface F3 faces a surface of a sheet S while the sheet S is being conveyed along the guide ribs 122.

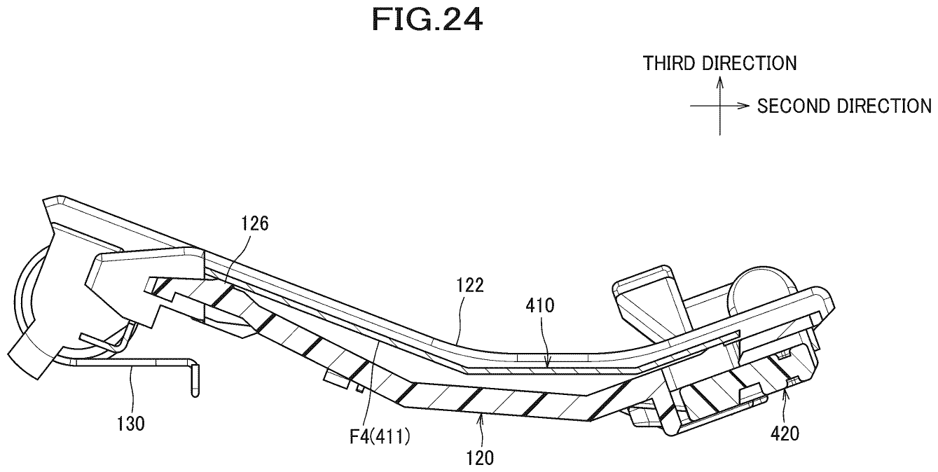

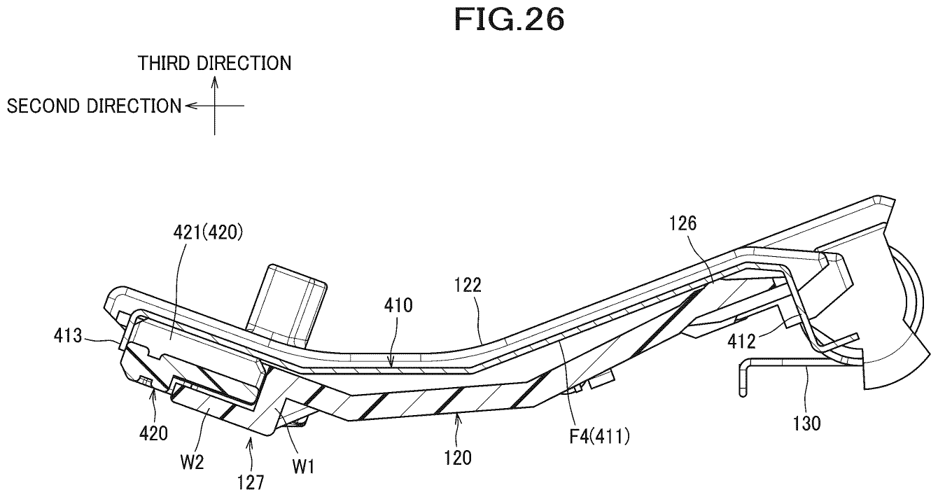

The back surface F4 is located on a lower end of the base portion 411. The back surface F4 is in contact with the ribs 126 of the chute body 120 (see FIGS. 24 and 26).

The upstream flange 412 extends downward from an upstream end of the base portion 411 in the conveyance direction and then extends upstream in the conveyance direction.

The downstream flange 413 extends downward from a downstream end of the base portion 411 in the conveyance direction (see also FIG. 26).

The slits 414 are openings through which the guide ribs 122 of the chute body 120 are allowed to pass. The slits 414 extend from the upstream flange 412, through the base portion 411, to the downstream flange 413. The downstream ends of the slits 414 have widths that gradually increase as the slits extend downstream in the conveyance direction.

The ends of the slits 414 in the conveyance direction are located under the guide ribs 122 and are engageable with the guide ribs 122 from below. The metal plate 410 is thereby restrained from moving upward with respect to the chute body 120.

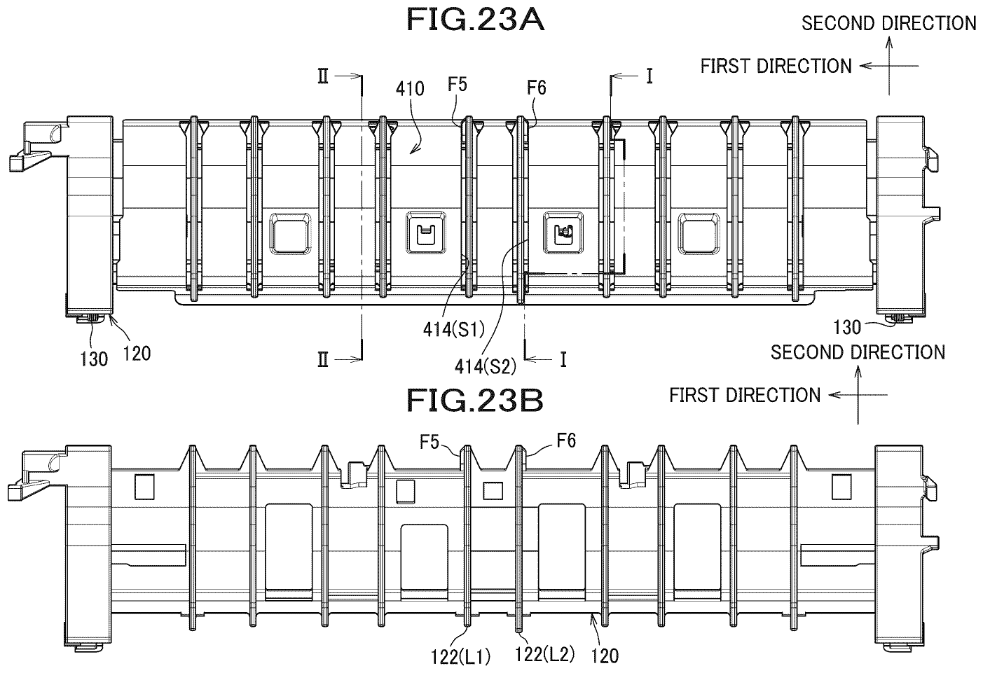

As shown in FIGS. 23A and 23B, the chute body 120 has a first location surface F5 and a second location surface F6 for locating the metal plate 410 in place in the first direction. The first location surface F5 and the second location surface F6 are perpendicular to the first direction. The first location surface F5 faces the one side in the first direction. The second location surface F6 faces the other side in the first direction.

The first location surface F5 is located on the one side in the first direction with respect to the two center guide ribs 122 of the plurality of guide ribs 122. The second location surface F6 is located on the other side in the first direction with respect to the two center guide ribs 122 of the plurality of guide ribs 122.

In the following description, the guide rib 122, of the two center guide ribs 122, on the one side in the first direction is also referred to as “first guide rib L1”, and the guide rib 122, of the two center guide ribs 122, on the other side in the first direction is also referred to as “second guide rib L2”. Further, the slit 414 in which the first guide rib L1 is received is also referred to as “first slit S1” and the slit 414 in which the second guide rib L2 is received is also referred to as “second slit S2”.

The first location surface F5 and the second location surface F6 are respectively in contact with edges of the slits 414 of the metal plate 410 in the first direction. Specifically, the first location surface F5 is in contact with an edge of the first slit S1 on the one side in the first direction. The second location surface F6 is in contact with an edge of the second slit S2 on the other side in the first direction.

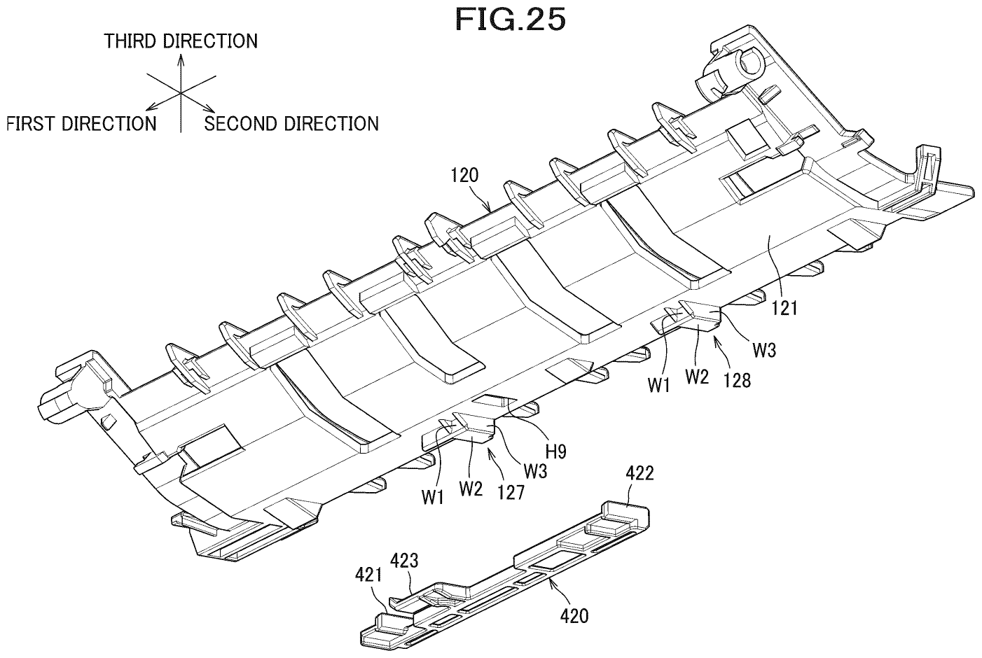

As shown in FIGS. 21 and 25, the attachment member 420 is an elongated member with a dimension in the first direction larger than dimensions in the second and third directions. The dimension of the attachment member 420 in the first direction is smaller than a dimension of the chute body 120 in the first direction.

The attachment member 420 includes a first portion 421, a second portion 422, and an arm 423.

The first portion 421 is located at an end of the attachment member 420 on the one side in the first direction.

The second portion 422 is located at an end of the attachment member 420 on the other side in the first direction.

The arm 423 is located between the first portion 421 and the second portion 422 in the first direction.

The arm 423 extends in the first direction. The arm 423 is elastically deformable in the third direction.

As shown in FIG. 25, the chute body 120 further includes a first retention portion 127, a second retention portion 128, and an engagement hole H9. The first retention portion 127 retains the first portion 421 of the attachment member 420. The second retention portion 128 retains the second portion 422 of the attachment member 420. The engagement hole H9 is engaged with the distal end of the arm 423.

The first retention portion 127 includes a first wall W1 and a second wall W2. The first wall W1 protrudes downward from the base portion 121. The second wall W2 protrudes downstream from a lower end of the first wall W1 in the conveyance direction. The second retention portion 128 has approximately the same structure as that of the first retention portion 127, and includes the first wall W1 and the second wall W2.

The first portion 421 of the attachment member 420 is sandwiched, as shown in FIG. 26, between the base portion 411 of the metal plate 410 and the second wall W2 of the first retention portion 127. The first portion 421 of the attachment member 420 is also sandwiched between the downstream flange 413 of the metal plate 410 and the first wall W1 of the chute body 120.

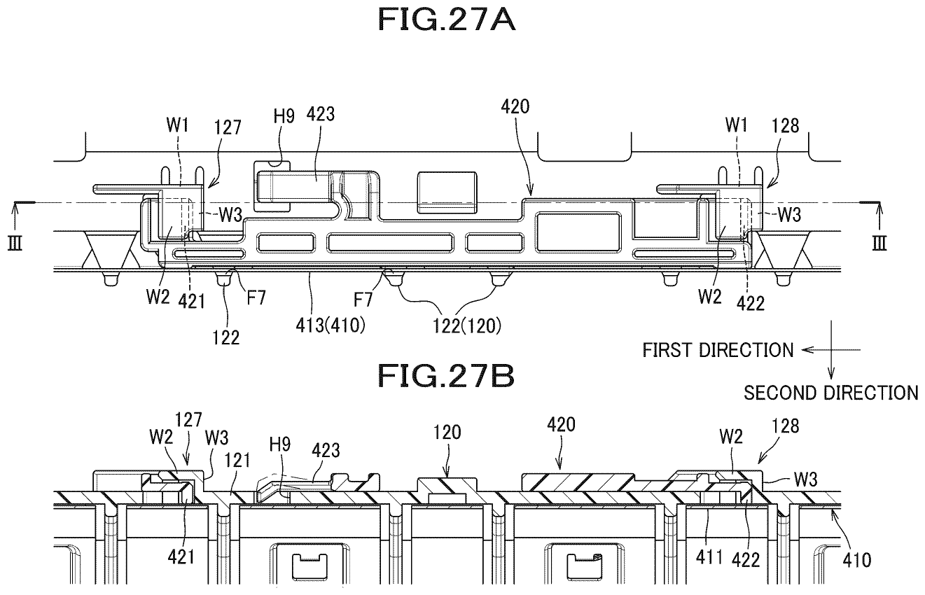

As shown in FIG. 27A, the downstream flange 413 of the metal plate 410 is in contact with an inclined surface F7 of the guide rib 122. The metal plate 410 is thereby restrained from moving downstream in the conveyance direction.

As shown in FIG. 27B, the second portion 422 of the attachment member 420 is sandwiched between the base portion 411 of the metal plate 410 and the second wall W2 of the second retention portion 128. As shown in FIG. 27A, the second portion 422 of the attachment member 420 is also sandwiched between the downstream flange 413 of the metal plate 410 and the first wall W1 of the chute body 120.

As shown in FIGS. 27A and 27B, the first retention portion 127 and the second retention portion 128 each includes a third wall W3.

The third wall W3 is located at an end of the first wall W1 on the other side in the first direction and connects the second wall W2 to the base portion 121.

As shown in FIG. 27B, the distal end of the arm 423 is movable between a first arm position shown by a dashed-double dotted line and a second arm position shown by a solid line. The first arm position is a position of the distal end of the arm 423 before the attachment member 420 is attached to the chute body 120 and the metal plate 410. The second arm position is a position of the distal end of the arm 423 after the attachment member 420 is attached to the chute body 120 and the metal plate 410.

The distal end of the arm 423 located in the second arm position is engaged in the engagement hole H9. When the arm 423 is engaged in the engagement hole H9, the arm 423 is in a deflected state. The attachment member 420 is thereby biased toward the other side in the first direction by an elastic force of the arm 423 attempting to return to the first arm position, and the first portion 421 and the second portion 422 are respectively pressed against the corresponding third walls W3 to locate the attachment member 420 in place in the first direction

Next, a method of attaching the metal plate 410 to the chute body 120 using the attachment member 420 will be described.

As shown in FIG. 21, an operator inserts the downstream ends of the plurality of guide ribs 122 of the chute body 120 into the downstream ends of the corresponding slits 414 formed in the metal plate 410, and thereby locates the downstream ends of the slits 414 below the guide ribs 122. Then, the operator inserts the upstream ends of the plurality of guide ribs 122 into the upstream ends of the corresponding slits 414, and thereby locates the upstream ends of the slits 414 below the guide ribs 122. By locating the upstream ends and the downstream ends of the slits 414 below the guide ribs 122, the upstream ends and the downstream ends of the slits 414 engage the guide ribs 122 if one attempts to move the metal plate 410 upward and thereby restrain the metal plate 410 from being detached upward from the chute body 120.

Subsequently, the operator moves the metal plate 410 downstream in the conveyance direction to place the downstream ends of the slits 414 in contact with the inclined surfaces F7 of the guide ribs 122. The metal plate 410 is thereby temporarily located in place relative to the chute body 120 in the conveyance direction.

Since the back surface F4 of the metal plate 410 is in contact with the ribs 126 in this state (see also FIG. 24), the metal plate 410 is located in place relative to the chute body 120 in the third direction. When the guide ribs 122 are inserted into the corresponding slits 414, the operator places, as shown in FIGS. 23A and 23B, an edge of the first slit S1 on the one side in the first direction in contact with the first location surface F5 and an edge of the second slit S2 on the other side in the first direction in contact with the second location surface F6. The metal plate 410 is thereby located in place relative to the chute body 120 in the first direction.

Thereafter, as shown in FIGS. 25 and 27B, the operator places the first portion 421 and the second portion 422 in positions where the first portion 421 and the second portion 422 are respectively shifted toward the one side in the first direction relative to the corresponding second walls W2, and then moves the attachment member 420 toward the other side in the first direction. The first portion 421 and the second portion 422 are thereby respectively inserted between the corresponding first walls W1 and the downstream flange 413 of the metal plate 410 and between the corresponding second walls W2 and the base portion 411 of the metal plate 410.

Since the first portion 421 and the second portion 422 are each located between the corresponding first wall W1 and the downstream flange 413, even if someone tries to move the metal plate 410 upstream in the conveyance direction, the metal plate 410 is restrained from being detached upstream from the chute body 120 in the conveyance direction as shown in FIG. 26, by the downstream flange 413 being engaged with the first portion 421 and other parts of the attachment member 420. Further, since the first portion 421 and the second portion 422 are each located between the corresponding first wall W1 and the downstream flange 413, the attachment member 420 is restrained from moving in the conveyance direction.

Since the first portion 421 and the second portion 422 are each located between the corresponding second wall W2 and the base portion 411 of the metal plate 410, the attachment member 420 is restrained from moving in the third direction.

Then, as shown in FIG. 27B, the operator engages the distal end of the arm 423 in the engagement hole H9 while deflecting the arm 423. As a result, the elastic force of the arm 423 biases the attachment portion 420 toward the other side in the first direction, the first portion 421 and the second portion 422 are each pressed against the corresponding third wall W3, and the attachment member 420 is located in place in the first direction.

According to the above-described embodiment, the following advantageous effects can be obtained.

Since the movable chute SH is movable to the third position further away, than the second position, from the straight line LN, the movable chute SH is movable within a range larger than a range in which the movable chute SH is moved by the controller CU. Thus, a space into which a user inserts his/her hand during a jam removal process can be enlarged.

Since the movable chute SH is movable from the first position toward the third position in a state where the movement device TM is not actuated, the movement device TM does not cause any resistance when the movable chute SH is moved to the third position. Thus, the movable chute SH can be moved smoothly.

Since the spring 130 biases the movable chute SH toward the first position, the moving speed of the movable chute SH can be restrained, by the spring 130, from becoming too fast when the user pushes the movable chute SH from the first position toward the third position with a strong force.

Since the movable chute SH is located in the first position when a sheet S is jammed during conveyance of the sheet S, the sheet S in contact with the movable chute SH will be located in the vicinity of the straight line LN if the sheet S is located between the transfer nip NP1 and the fixing nip NP2. Thus, the user can easily grasp the sheet S.

Since the movable chute SH is pushed by the movement device TM from a guide-surface 122A side, it is not necessary to locate the movement device TM within a space on the third-position side of the movable chute SH located in the first position. Thus, the movable chute SH can be moved smoothly.

Since the linkage 200 pushes the movable chute SH, the amount of travel of the movable chute SH from the first position to the second position can be increased.

Since the distal end of the movable chute SH located in the first position is located above the transfer roller 53, the sheet S is supported by the distal end of the movable chute SH located in the first position when the sheet S is jammed at a location between the transfer nip NP1 and the fixing nip NP2. Thus, the user can easily grasp the trailing edge of the sheet S. Further, when the sheet S is supported by the distal end of the movable chute SH located in the first position, a space is likely to be formed between the movable chute SH and the sheet S. Therefore, the user can insert his/her fingers into the space and easily grasp the sheet S.

Since the fixing device 6 comprises the fixing shutter 500, it is possible to restrain, by the fixing shutter 500, a user's hand from entering the fixing housing 63 in the jam removal process in which the sheet S is jammed at a location between the transfer nip NP1 and the fixing nip NP2.

Since the fixing shutter 500 is opened and closed in conjunction with installation and removal of the process cartridge 50, the fixing shutter 500 closes when the user removes the process cartridge 50 from the main housing in the jam removal process in which the sheet S is jammed at a location between the transfer nip NP1 and the fixing nip NP2. Thus, the user's hand can be more reliably restrained from entering the fixing housing 63.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The toner image carrier is not limited to the photosensitive drum. The toner image carrier may, for example, be an intermediate transfer belt on which a toner image is transferred from a photosensitive drum. In this case, the transfer roller transfers a toner image on the intermediate transfer belt onto a sheet. The transfer roller forms a transfer nip in combination with the intermediate transfer belt. The transfer nip is formed between the transfer roller and the intermediate transfer belt.

The cartridge is not limited to the process cartridge 50. For example, the cartridge may not comprise a transfer roller.

The rotatable heating body may be a heating roller.

The rotatable pressure body may be an endless belt held between a heating roller and a rubber pad.

The second position may be a position above the first position. The third position may be a position above the second position. In this case, the movement device may push the movable chute upward. Further, since the movement device supports the movable chute from below in this case, the spring biasing the movable chute toward the first position may not be required.

The movement device may comprise a motor and a rack and pinion mechanism.

The movement device may be connected to the movable chute. In this case, the movement device may move together with the movable chute when the user moves the movable chute.

The spring is not limited to a torsion spring and may be a helical compression spring, a helical extension spring, a leaf spring, etc.

The controller may control the movement device to locate the movable chute in the second position when it determines that a sheet is jammed during conveyance of the sheet. Further, the controller may locate the movable chute in the second position when printing control is not being executed.

The movable chute may be linearly movable. The distal end of the movable chute may face an upstream side in the conveyance direction.

The fixing shutter may be linearly movable.

The image forming apparatus is not limited to a laser printer, and may, for example, be a copying machine, a multifunctional device, etc.

The elements described in the above embodiment and its modified examples may be implemented selectively and in combination.

What is claimed is:

1. An image forming apparatus, comprising:
a toner image carrier configured to carry a toner image;
a transfer roller configured to form a transfer nip with the toner image carrier and to transfer the toner image on the toner image carrier onto a sheet;
a fixing device configured to fix the transferred toner image on the sheet, the fixing device comprising:
a rotatable heating body configured to heat the sheet; and
a rotatable pressure body configured to form a fixing nip with the rotatable heating body and to apply pressure to the sheet;
a movable chute configured to guide the sheet, the movable chute being located downstream of the transfer roller and upstream of the fixing device in a direction of conveyance of the sheet, and movable between a first position and a second position located further away, than the first position, from a straight line connecting a downstream edge of the transfer nip and an upstream edge of the fixing nip as viewed in an axial direction of the transfer roller;
a movement device configured to move the movable chute; and
a controller configured to control the movement device to move the movable chute only between the first position and the second position,
wherein the movable chute is movable to a third position located further away, than the second position, from the straight line.

2. The image forming apparatus according to claim 1, wherein the movable chute is movable in a direction from the first position toward the third position in a state where the movement device is not actuated.

3. The image forming apparatus according to claim 2, further comprising a spring that biases the movable chute toward the first position.

4. The image forming apparatus according to claim 1, wherein the controller is configured to control the movement device, if it is determined that a sheet is jammed during conveyance of the sheet, to position the movable chute at the first position.

5. The image forming apparatus according to claim 1,
wherein the movement device comprises a solenoid actuator, and
wherein the controller controls the solenoid actuator to move the movable chute between the first position and the second position.

6. The image forming apparatus according to claim 5,
wherein the movable chute has a guide surface that guides a sheet, and
wherein the movement device has a pushing surface that pushes the movable chute from a guide-surface side of the movable chute.

7. The image forming apparatus according to claim 6, further comprising a linkage configured to be moved by a driving force of the solenoid actuator,
wherein the linkage comprises:
a first link with one end connected to the solenoid actuator and movable in the axial direction;
a second link connected to another end of the first link and rotatable about a first axis in response to movement of the first link; and
a third link connected to the second link and having the pushing surface, the third link configured to push the movable chute toward the second position in response to rotation of the second link.

8. The image forming apparatus according to claim 4,
wherein the movable chute is rotatable about a second axis, and extends downstream from the second axis in the direction of conveyance,
wherein the second position is lower than the first position, and
wherein a distal end of the movable chute is located above the transfer nip when the movable chute is located in the first position, and the distal end of the movable chute is located below the transfer nip when the movable chute is located in the second position.

9. The image forming apparatus according to claim 1, wherein a downstream end of the movable chute in the direction of conveyance is located further away from the straight line when the movable chute is located in the second position than when the movable chute is located in the first position, and is located further away from the straight line when the movable chute is located in the third position than when the movable chute is located in the second position.

10. An image forming apparatus, comprising:
a transfer roller configured to transfer a toner image onto a sheet;
a fixing device configured to fix the transferred toner image on the sheet;
a movable chute configured to guide the sheet, the movable chute being located downstream of the transfer roller and upstream of the fixing device in a direction of conveyance of the sheet, and movable to a first position, to a second position, and to a third position in this order in a direction nonparallel to a surface of the sheet;
a movement device configured to move the movable chute; and
a controller configured to control the movement device to move the movable chute only between the first position and the second position.

11. The image forming apparatus according to claim 1, wherein the fixing device comprises:
a fixing housing having an opening through which a sheet conveyed toward the fixing device passes; and
a fixing shutter configured to move between an open position in which the opening is uncovered and a closed position in which the opening is covered.

12. The image forming apparatus according to claim 11, further comprising:
a main housing; and
a cartridge installable into and removable from the main housing,
wherein the fixing shutter moves from the closed position to the open position in the process of the cartridge being installed into the main housing, and
wherein the fixing shutter moves from the open position to the closed position in the process of the cartridge being removed from the main housing.
